(19) United States
(12) Patent Application Publication
(10) Pub. No.: US 2008/0231199 A1
(43) Pub. Date: Sep. 25, 2008

(54) Driving method for organic electroluminescence light emitting section

(75) Inventors: Tetsuro Yamamoto, Kanagawa (JP); Katsuhide Uchino, Kanagawa (JP); Naobumi Toyomura, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/073,928

(22) Filed: Mar. 12, 2008

(30) Foreign Application Priority Data
Mar. 20, 2007 (JP) 2007-072504

(51) Int. Cl. G09G 3/10; G09G 3/12

(52) U.S. Cl. 315/169.3; 345/45; 345/76

(57) ABSTRACT

A driving method for an organic electroluminescence light emitting section of an organic EL display apparatus which includes a scanning circuit, an image signal outputting circuit, totaling N×M organic electroluminescence elements, M scanning lines, N data lines, and a current supplying section. The driving method, includes the steps of: carrying out a preprocess; carrying out a threshold voltage cancellation process; carrying out a wiring process; and supplying current to the organic electroluminescence light emitting section to drive the organic electroluminescence light emitting section.

### CROSS REFERENCES TO RELATED APPLICATIONS

The present invention contains subject matter related to Japanese Patent Application JP 2007-072504 filed with the Japan Patent Office on Mar. 20, 2007, the entire contents of which being incorporated herein by reference.

### BACKGROUND OF THE INVENTION

1. Field of the Invention

This invention relates to a driving method for an organic electroluminescence light emitting section.

2. Description of the Related Art

In an organic electroluminescence display apparatus (herein after referred to simply as organic EL display apparatus) wherein an organic electroluminescence device (hereinafter referred to simply as organic EL element) is used as a light emitting element, the luminance of the organic EL element is controlled by the value of current which flows through the organic EL element. Then, similarly as in a liquid crystal display apparatus, also in an organic EL display apparatus, a simple matrix method and an active matrix method are well known as driving methods. While the active matrix method has a drawback that the structure is complicated when compared with that in the simple matrix method, the active matrix method has such various advantages that the luminance of an image can be increased.

As a circuit for driving an organic electroluminescence light emitting section (hereinafter referred to simply as light emitting section) which forms an organic EL element, a driving circuit (hereinafter referred to as 5Tr/1C driving circuit) composed of five transistors and one capacitor section is well known and disclosed, for example, in Japanese Patent Laid-Open No. 2006-215213. Referring to FIG. 2, the existing 5Tr/1C driving circuit mentioned is shown. The 5Tr/1C driving circuit includes five transistors of an image signal writing transistor T_{Sig}, a driving transistor T_{Drv}, a light emission control transistor T_{EL}_{_{—}}_{C}, a first node initialization transistor T_{ND1} and a second node initialization transistor T_{ND2} and one capacitor section C₁. Here, the other one of the source/drain regions of the driving transistor T_{Drv} forms a second node ND₂, and the gate electrode of the driving transistor T_{Drv} forms a first node ND₁.

It is to be noted that the transistors and the capacitor section are hereinafter described in detail.

For example, the transistors are individually formed from an n-channel thin film transistor (TFT) and a light emitting section ELP is provided on an interlayer insulating layer or the like formed so as to cover the driving circuit. The anode electrode of the light emitting section ELP is connected to the other one of the source/drain regions of the driving transistor T_{Drv}. On the other hand, a voltage V_{Cat}, for example, 0 volt, is applied to the cathode electrode of the light emitting section ELP. Reference character C_{EL} denotes parasitic capacitance of the light emitting section ELP.

A timing chart of driving is schematically shown in FIG. 4, and on/off states and so forth of transistors which form the driving circuit shown in FIG. 2 are illustrated in FIGS. 6A to 6D and 7A to 7E. Referring to FIG. 4, a preprocess for carrying out a threshold voltage cancellation process is executed within a [period−TP(5)₁]. In particular, if the first node initialization transistor T_{ND1} and the second initialization transistor T_{ND2} are placed into an on state as seen in FIG. 6B, then the potential at the first node ND₁ becomes V_{Ofs}, for example, 0 volt. On the other hand, the potential at the second node ND₂ becomes V_{SS}, for example, −10 volts. Consequently, the potential difference between the gate electrode of the driving transistor T_{Drv} and the other one of the source/drain regions of the driving transistor T_{Drv} becomes higher than a threshold voltage Vₜₕ of the driving transistor T_{Drv} and the driving transistor T_{Drv} is placed into an on state.

Then, the threshold voltage cancellation process is carried out within periods of [period−TP(5)₂] and [period−TP(5)₃] as seen in FIG. 4. In particular, as seen in FIG. 6D, the light emission control transistor T_{EL}_{_{—}}_{C} is placed into an on state while the on state of the first node initialization transistor T_{ND1} is maintained. As a result, the potential at the second node ND₂ varies toward the potential of the difference of the threshold voltage Vₜₕ of the driving transistor T_{Drv} from the potential at the first node ND₁. In other words, the potential at the second node ND₂ in a floating state rises. Then, when the potential difference between the gate electrode and the other one of the source/drain regions of the driving transistor T_{Drv} reaches the threshold voltage Vₜₕ, the driving transistor T_{Drv} enters an off state. In this state, the potential at the second node ND₂ is approximately V_{Ofs}−Vₜₕ. Thereafter, within a [period−TP(5)₃], the light emission control transistor T_{EL}_{_{—}}_{C} is placed into an off state while the on state of the first node initialization transistor T_{ND1} is maintained. Then, the first node initialization transistor T_{ND1} is placed into an off state within a [period−TP(5)₄].

Thereafter, a writing process for the driving transistor T_{Drv} is carried out within a [period−TP(5)₅] as seen in FIG. 4. In particular, as seen in FIG. 7C, while the off state of the first node initialization transistor T_{ND1}, second node initialization transistor T_{ND2} and light emission control transistor T_{EL}_{_{—}}_{C} is maintained, the potential at a data line DTL is set to a voltage corresponding to the image signal, that is, to the image signal (driving signal or luminance signal) voltage V_{Sig} for controlling the luminance of the light emitting section ELP, and then, a scanning line SCL is placed into a high-level state so that the image signal writing transistor T_{Sig} is placed into an on state. As a result, the potential at the first node ND₁ increases to the image signal voltage V_{Sig}. Charge based on the variation amount of the potential of the first node ND₁ is distributed to the capacitor section C₁, the parasitic capacitance C_{EL} of the light emitting section ELP and the parasitic capacitance between the gate electrode and the source region of the driving transistor T_{Drv}. Accordingly, if the potential at the first node ND₁ varies, then also the potential at the second node ND₂ varies. However, the variation of the potential of the second node ND₂ decreases as the capacitance value of the parasitic capacity C_{EL} of the light emitting section ELP increases. Generally, the capacitance value of the parasitic capacitance C_{EL} of the light emitting section ELP is higher than the capacitance value of the capacitor section C₁ and the value of the parasitic capacitance of the driving transistor T_{DRV}. Therefore, if the potential of the second node ND₂ little varies, then the potential difference V_{gs} between the gate electrode and the other one of the source/drain regions of the driving transistor T_{Drv} is given by the following expression (A):

V_{gs}≈V_{Sig}−(V_{Ofs}−Vₜₕ) (A)

Thereafter, a mobility correction process of raising the potential in the other one of the source/drain regions of the driving transistor T_{Drv} or at the second node ND₂ based on a characteristic such as, for example, the magnitude of the mobility μ of the driving transistor T_{Drv} is carried out within a (period−TP(5)₆] as seen in FIG. 4. In particular, as seen in FIG. 7D, the light emission control transistor T_{EL}_{_{—}}_{C} is placed into an on state while the on state of the driving transistor T_{Drv} is maintained, and then, after a predetermined time period t₀ passes, the image signal writing transistor T_{Sig} is placed into an off state. As a result, where the value of the mobility μ of the driving transistor T_{Drv} is high, the increasing amount ΔV or potential correction value of the potential in the other of the source/drain regions of the driving transistor T_{Drv} becomes high, but, where the value of the mobility μ of the driving transistor T_{Drv} is low, the increasing amount ΔV or potential correction value of the potential in the other of the source/drain regions of the driving transistor T_{Drv} becomes low. Here, the potential difference V_{gs} between the gate electrode and the other of the source/drain regions of the driving transistor T_{Drv} is transformed from the expression (A) into another expression (B) given below. It is to be noted that the predetermined time period, that is, the total time period t₀ within the [period−TP(5)₆] for executing the mobility correction process may be determined in advance as a design value upon designing of the organic EL display apparatus.

V_{gs}≈V_{Sig}−(V_{Ofs}−Vₜₕ)−ΔV (B)

By the operation described above, the threshold voltage cancellation process, writing process and mobility correction process are completed. Thereafter, within a [period−TP(5)₇], the image signal writing transistor T_{Sig} is placed into an off state and the first node ND₁, that is, the gate electrode of the driving transistor T_{Drv}, is placed into a floating state as seen in FIG. 7E. On the other hand, the light emission control transistor T_{EL}_{_{—}}_{C} maintains the on state and one of the source/drain regions of the light emission control transistor T_{EL}_{_{—}}_{C} is in a connected state to a current supplying section of a voltage V_{CC}, for example, 20 volts for controlling light emission of the light emitting section ELP. As a result, the potential at the second node ND₂ increases, and a phenomenon similar to that in a bootstrap circuit occurs with the gate electrode of the driving transistor T_{Drv} and also the potential at the first node ND₁ increases. As a result, the potential difference V_{gs} between the gate electrode and the other of the source/drain region of the driving transistor T_{Drv} maintains a value same as the value obtained from the expression (B). Further, since current which flows through the light emitting section ELP is drain current I_{ds} which flows from the drain region of the driving transistor T_{Drv} to the source region, the current can be represented by an expression (C). The light emitting section ELP emits light with the luminance corresponding to the value of the drain current I_{ds}.

$$\begin{matrix}{I}_{ds} = k \cdot μ \cdot {( {V}_{gs} - {V}_{th} )}^{2} \\ = k \cdot μ \cdot {( {V}_{Sig} - {V}_{Ofs} - Δ V )}^{2}\end{matrix} \qquad ( C )$$

Also driving and so forth of the 5Tr/1C driving circuit whose outline is described above are hereinafter described in detail.

Incidentally, referring to FIG. 3, an organic EL display apparatus includes:

(1) a scanning circuit 101;

(2) an image signal outputting circuit 102;

(3) totaling N×M organic EL elements 10 arrayed in a two-dimensional matrix wherein N organic EL elements 10 are arranged in a first direction and M organic EL elements 10 are arranged in a second direction, particularly a direction perpendicular to the first direction, and each including an organic electroluminescence light emitting section ELP and a driving circuit for driving the organic electroluminescence light emitting section ELP;

(4) M scanning lines SCL connected to the scanning circuit 101 and extending in the first direction;

(5) N data lines DTL connected to the image signal outputting circuit 102 and extending in the second direction; and

(6) a current supplying section 100.

It is to be noted that, while, in FIG. 3, 3×3 organic EL elements 10 are shown for the convenience of description, they are a mere example to the end.

Each of the organic EL elements 10 includes a 5Tr/1C driving circuit and a light emitting section ELP as described hereinabove. Operation of the light emission control transistor T_{EL}_{_{—}}_{C} is defined by the voltage applied to the light emission controlling transistor control line CL_{EL}_{_{—}}_{C} connected to the light emission controlling transistor control circuit 103. In the threshold voltage cancellation process described above, the light emission controlling transistor control circuit 103 operates to apply a predetermined voltage such as, for example, 30 volts for placing the light emission control transistor T_{EL}_{_{—}}_{C} into an on state to the light emission controlling transistor control line CL_{EL}_{_{—}}_{C} within the [period−TP(5)₂]. Further, another predetermined voltage such as, for example, −10 volts for placing the light emission control transistor T_{EL}_{_{—}}_{C} into an off state is applied to the light emission controlling transistor control line CL_{EL}_{_{—}}_{C} within the [period−TP(5)₃]. Furthermore, within and after the [period−TP(5)₆], the predetermined voltage of 30 volts for placing the light emission control transistor T_{EL}_{_{—}}_{C} into an on state is applied to the light emission controlling transistor control line CL_{EL}_{_{—}}_{C}. Accordingly, as hereinafter described with reference to FIG. 20, the waveform AF₀ of the signal of the light emission controlling transistor control circuit 103 is a rectangular waveform having basically two values of −10 volts and 30 volts.

### SUMMARY OF THE INVENTION

Generally, the waveform of a signal which propagates along a wiring line is deformed and becomes dull at rising and falling edges of the signal by an influence of distributed capacity and so forth. The degree of the deformation increases as the length of the path along which the signal is to be transmitted increases. For example, if attention is paid to the signal of the light emission controlling transistor control circuit 103, then an organic EL element 10 nearest to the light emission controlling transistor control circuit 103 and another organic EL element 10 displaced most far from the light emission controlling transistor control circuit 103 are different each other. The organic EL element 10 nearest to the light emission controlling transistor control circuit 103, that is, an organic EL element 10 arrayed at the left end. The another organic EL element 10 displaced most far from the light emission controlling transistor control circuit 103, that is, an organic EL element 10 arrayed at the right end in the organic EL display apparatus shown in FIG. 3. Particularly, they are different in the length of the path along which a signal is transmitted, or in other words, the length of a portion of the light emission controlling transistor control line CL_{EL}_{_{—}}_{C} from each organic EL element 10 to the light emission controlling transistor control circuit 103. FIG. 19 schematically illustrates a relationship among the organic EL elements 10 in the first row, the light emission controlling transistor control circuit 103 and the light emission controlling transistor control line CL_{EL}_{_{—}}_{C}.

In the example of FIG. 19, the path length of the organic EL element 101 is smallest while the path length of the organic EL element 10_{N} is greatest. Accordingly, the waveform AF₀ of the signal of the light emission controlling transistor control circuit 103 is transmitted in a comparatively greatly deformed state to the organic EL element 10_{N} arrayed at the right end. The waveforms AF₀, AF₁ and AF_{N} of a signal which propagates along the light emission controlling transistor control line CL_{EL}_{_{—}}_{C} of the organic EL display apparatus within the periods of [period−TP(5) ₂] to [period−TP(5)₇] described hereinabove are schematically shown in FIG. 19. The waveform AF₀ of the signal of the light emission controlling transistor control circuit 103 is a rectangular waveform having two values including a voltage such as, for example, 30 volts for placing the light emission control transistor T_{EL}_{_{—}}_{C} into an on state and another voltage such as, for example, −10 volts for placing the light emission control transistor T_{EL}_{_{—}}_{C} into an off state. The waveform AF₀ is applied to the gate electrode of the light emission control transistor T_{EL}_{_{—}}_{C}. As seen in FIG. 19, the waveform AF₁ which has little deterioration from the waveform AF₀ which is the original waveform is transmitted to the organic EL element 10₁ and is applied to the gate electrode of the light emission control transistor T_{EL}_{_{—}}_{C} of the organic EL element 10₁. On the other hand, the waveform AF_{N} of a deformed, substantially trapezoidal shape is transmitted to the organic EL element 10_{N} and applied to the gate electrode of the light emission control transistor T_{EL}_{_{—}}_{C} of the organic EL element 10_{N}. FIG. 20 illustrates the waveforms AF₀, AF₁ and AF_{N} shown in FIG. 19 and the timing chart shown at an upper portion of FIG. 4 for comparison.

Here, the difference in potential variation which occurs at a node between the light emission control transistor T_{EL}_{_{—}}_{C} and the driving transistor T_{Drv}, more particularly between source/drain regions A₁ and A₂ hereinafter described when the waveform AF₁ described hereinabove is applied to the gate electrode of the light emission control transistor T_{EL}_{_{—}}_{C} and the waveform AF_{N} is applied to the gate electrode of the light emission control transistor T_{EL}_{_{—}}_{C} within, before and after the [period−TP(5)₂] within which the threshold value cancellation process described hereinabove is carried out is examined. FIGS. 21A and 21B illustrate operation of the driving circuit within the periods of [period−TP(5)₂] to [period−TP(5)₃] described hereinabove. The parasitic capacitance between the gate electrode and the source/drain region A₁ of the light emission control transistor T_{EL}_{_{—}}_{C} is represented by C_{A1}, and the parasitic capacitance between the gate electrode and the source/drain region A₂ of the driving transistor T_{Drv} is represented by C_{A2}.

As described hereinabove, at an initial timing of the [period−TP(5)₂], the driving transistor T_{Drv} is in an on state. Then, since the light emission control transistor T_{EL}_{_{—}}_{C} is placed into an on state, the potential at the second node ND₂ in a floating state rises. Thereupon, when the potential difference between the gate electrode and the other one of the source/drain regions of the driving transistor T_{Drv} reaches the threshold voltage Vₜₕ, the driving transistor T_{Drv} is placed into an off state. Consequently, as seen on the left side of FIG. 21A, the driving transistor T_{Drv} is in an off state at rising and falling edges of the waveform AF₁ and the waveform AF_{N}. Accordingly, at falling edges of the waveform AF₁ and the waveform AF_{N}, if the light emission control transistor T_{EL}_{_{—}}_{C} is in an on state, then the source/drain regions A₁ and A₂ are not in a floating state because the voltage V_{CC} is applied thereto, but if the light emission control transistor T_{EL}_{_{—}}_{C} is placed into an off state, then the source/drain regions A₁ and A₂ are placed into a floating state. When the node between the light emission control transistor T_{EL}_{_{—}}_{C} and the driving transistor T_{Drv}, that is, at the source/drain regions A₁ and A₂, is in a floating state, if the potential at the gate electrode of the light emission control transistor T_{EL}_{_{—}}_{C} varies, then also the potential in the source/drain regions A₁ and A₂ varies by electrostatic coupling by the parasitic capacitance C_{A1} and so forth.

Here, the waveform AF_{N} exhibits a dull state at a falling edge with respect to the waveform AF₁. ΔT₁ appearing at a lower portion of FIG. 20 and in FIG. 21 represents a period of time till a point of time at which the light emission control transistor T_{EL}_{_{—}}_{C} changes over between an on state and an off state at a falling edge of the waveform AF₁. If the waveform AF₁ has an ideal rectangular waveform, then the time ΔT₁ is zero. Similarly, ΔTₙ appearing at a lower portion of FIG. 20 and in FIG. 21 represents a period of time till a point of time at which the light emission control transistor T_{EL}_{_{—}}_{C} changes over between an on state and an off state at a falling edge of the waveform AF_{N}. As apparently seen from FIGS. 20 and 21, ΔT₁<ΔTₙ. As described hereinabove, if the light emission control transistor T_{EL}_{_{—}}_{C} is in an on state, then the voltage V_{CC} is applied to the source/drain regions A₁ and A₂. Accordingly, at a falling edge of the waveform AF_{N}, the voltage V_{CC} is applied to the source/drain regions A₁ and A₂ for a period of time longer by ΔTₙ−ΔT₁. In other words, at a falling edge of the waveform AF_{N}, the potential at the source/drain regions A₁ and A₂ is maintained rather on the voltage V_{CC} side with respect to that at a falling edge of the waveform AF₁. Consequently, as seen in FIG. 21B, at falling edges of the waveform AF₁ and the waveform AF_{N}, the potential variation at the source/drain regions A₁ and A₂ by electrostatic coupling appears more conspicuously with the waveform AF₁. More particularly, if the driving circuit to which the waveform AF₁ is applied and the driving circuit to which the waveform AF_{N} is applied are compared with each other, then the potential at the node between the light emission control transistor T_{EL}_{_{—}}_{C} and the driving transistor T_{Drv} in the former driving circuit varies by a greater amount to the negative side.

The potential variation at the node between the light emission control transistor T_{EL}_{_{—}}_{C} and the driving transistor T_{Drv} propagates finally to the second node ND₂ by electrostatic coupling through the parasitic capacitance C_{A2} and so forth. Consequently, some difference occurs at the potential at the second node ND₂ between the driving circuit to which the waveform AF₁ is applied and the driving circuit to which the waveform AF_{N} is applied. From this, the value of the drain current varies within the [period−TP(5)₇]. In other words, the difference appears at the luminance of the light emitting section ELP between the organic EL element 10₁ arrayed at the left end and the organic EL element 10_{N} arrayed at the right end. Further, although a similar phenomenon occurs also with the other organic EL elements 10, the degree of occurrence of the phenomenon varies depending upon the degree of deformation of the signal waveform. As described hereinabove, the degree of deformation of the signal waveform varies depending upon the length of the portion of the light emission controlling transistor control line CL_{EL}_{_{—}}_{C} from each organic EL element 10 to the light emission controlling transistor control circuit 103. After all, in the example illustrated in FIG. 19, a phenomenon that the luminance of the organic EL display apparatus gradually varies from the left end to the right end of the screen image occurs. This deteriorates the uniformity in luminance of the display screen image.

Therefore, it is demanded to provide a driving method for an organic electroluminescence light emitting section which can suppress deterioration of the uniformity in luminance of a display screen image caused by deformation of a signal waveform which propagates along a light emission controlling transistor control line.

According to the present embodiment, there is provided a driving method for an organic electroluminescence light emitting section of an organic EL display apparatus which includes:

(1) a scanning circuit;

(2) an image signal outputting circuit;

(3) totaling N×M organic electroluminescence elements disposed in a two-dimensional matrix wherein N organic electroluminescence elements are arrayed in a first direction and M organic electroluminescence elements are arrayed in a second direction different from the first direction and each including an organic electroluminescence light emitting section and a driving circuit for driving the organic electroluminescence light emitting section;

(4) M scanning lines connected to the scanning circuit and extending in the first direction;

(5) N data lines connected to the image signal outputting circuit and extending in the second direction; and

(6) a current supplying section;

the driving circuit including:

(A) a driving transistor including source/drain regions, a channel formation region, and a gate electrode;

(B) an image signal writing transistor including source/drain regions, a channel formation region, and a gate electrode;

(C) a light emission control transistor including source/drain regions, a channel formation region, and a gate electrode; and

(D) a capacitor section having a pair of electrodes;

the driving transistor being configured such that:

(A-1) a first one of the source/drain regions is connected to a second one of the source/drain regions of the light emission control transistor; that

(A-2) a second one of the source/drain regions is connected to an anode electrode provided in the organic electroluminescence light emitting section and is connected to a first one of the electrodes of the capacitor section to form a second node; and that

(A-3) the gate electrode is connected to a second one of the source/drain regions of the image signal writing transistor and is connected to a second one of the electrodes of the capacitor section to form a first node;

the image signal writing transistor being configured such that:

(B-1) a first one of the source/drain regions is connected to a data line; and that

(B-2) the gate electrode is connected to a scanning line;

the light emission control transistor being configured such that:

(C-1) a first one of the source/drain regions is connected to a current supplying section; and that

(C-2) the gate electrode is connected to a light emission control transistor control line;

the driving method including the steps of:

(a) carrying out a preprocess of applying a first node initialization voltage to the first node and applying a second node initialization voltage to the second node so that a potential difference between the first and second nodes exceeds a threshold voltage of the driving transistor and a potential difference between the second node and a cathode electrode of the organic electroluminescence light emitting section does not exceed a threshold voltage of the organic electroluminescence light emitting section;

(b) carrying out a threshold voltage cancellation process for varying the potential at the second node toward a potential of the difference of the threshold voltage of the driving transistor from the potential at the first node while the potential at the first node is maintained;

(c) carrying out a wiring process of applying an image signal from the data line to the first node through the image signal writing transistor which is placed into an on state with a signal from the scanning line; and

(d) placing the image signal writing transistor into an off state with a signal from the scanning line to place the first node into a floating state and supplying current corresponding to the value of the potential difference between the first node and the second node from the current supplying section to the organic electroluminescence light emitting section through the light emission control transistor and the driving transistor;

the step (b) including the steps of:

(b-1) applying a first voltage for placing the light emission control transistor into an on state to the gate electrode of the light emission control transistor through the light emission controlling transistor control section to connect one of the source/drain regions of the driving transistor to the current supplying section through the light emission controlling transistor in the on state to set the potential at the one of the source/drain region of the driving transistor to a potential higher than the potential at the second node at the step (a); and

(b-2) applying a second voltage for placing the light emission controlling transistor to the gate electrode of the light emission controlling transistor through the light emission controlling transistor control line;

the step (d) further including applying a third voltage for placing the light emission controlling transistor into an on state to the gate electrode of the light emission controlling transistor through the light emission controlling transistor control line and connecting the one of the source/drain regions of the driving transistor to the current supplying section through the light emission controlling transistor in an on state to supply current corresponding to the value of the potential difference between the first node and the second node to the organic electroluminescence light emitting section;

the first, second and third voltages satisfying IV₁_{_{—}}_{ON}−V₂_{_{—}}_{OFF}|<|V₃_{_{—}}_{ON}−V₂_{_{—}}_{OFF}| where V₁_{_{—}}_{ON} is the first voltage, V₂_{—}_{_{OFF}} is the second voltage and V₃_{_{—}}_{ON} is the third voltage.

Preferably, the driving method is configured such that the driving circuit further includes:

(E) a second node initialization transistor including source/drain regions, a channel formation region, and a gate electrode; and in the second node initialization transistor:

(E-1) a first one of the source/drain regions is connected to a second node initialization voltage supply line;

(E-2) a second one of the source/drain regions is connected to the second node; and

(E-3) the gate electrode is connected to a second node initialization transistor control line; and

at the step (a), a second node initialization voltage is applied from the second node initialization voltage supply line to the second node through the second node initialization transistor which is placed in an on state with a signal from the second node initialization transistor control line, and then the second node initialization transistor is placed into an off state with a signal from the second node initialization transistor control line.

Further preferably, the driving method is configured further such that the driving circuit further includes:

(F) a first node initialization transistor including source/drain regions, a channel formation region, and a gate electrode; and wherein, in the first node initialization transistor:

(F-1) a first one of the source/drain regions is connected to a first node initialization voltage supply line;

(F-2) a second one of the source/drain regions is connected to the first node; and

(F-3) the gate electrode is connected to the first node initialization control line; and

at the step (a), a first node initialization voltage is applied from the first node initialization voltage supply line to the first node through the first node initialization transistor which is placed in an on state with a signal from the first node initialization transistor control line.

In the driving method, the first voltage V₁_{_{—}}_{ON} may be set suitably in accordance with the design of the organic EL display apparatus. For example, the first voltage V₁_{—}_{ON} may be set with reference to a critical value, that is, a critical voltage, at which, for example, the operation of the light emission control transistor is changed over from a linear region to an unsaturated region. If the light emission control transistor is, for example, of the n-channel type and the critical voltage disperses within a range of a design value of ±V₀ volts with respect to the critical value, then the first voltage V₁_{_{—}}_{ON} may be set with reference to a value a little lower than the lower limit to the dispersion, that is, the design value of −V₀ volts with respect to the critical voltage. Similarly, where the light emission control transistor is of the p-channel type, the first voltage V₁_{_{—}}_{ON} may be set with reference to a value a little higher than the design value of +V₀ volts with respect to the critical voltage.

In the driving method, at the step (b), the threshold voltage cancellation process for varying the potential at the second node toward the potential of the difference of the threshold voltage of the driving transistor from the potential at the first node is carried out. Qualitatively, the degree with which the potential difference between the first node and the second node, that is, the potential difference between the gate electrode and the source region of the driving transistor T_{Drv}, in the threshold voltage cancellation process, approaches the threshold voltage of the driving transistor, depends upon the time of the threshold voltage cancellation process. Accordingly, for example, in a form wherein the time for the threshold voltage cancellation process is assured sufficiently long, the potential at the second node reaches the potential of the difference of the threshold voltage of the driving transistor from the potential at the first node. Then, the potential difference between the first node and the second node reaches the threshold voltage of the driving transistor, and the driving transistor is placed into an off state. On the other hand, for example, in another form wherein it cannot be avoided to set short the time for the threshold voltage cancellation process, the potential difference between the first node and the second node sometimes becomes greater than the threshold voltage of the driving transistor, and consequently, the driving transistor may not be placed into an off state. In the driving method of the present embodiment, the driving transistor need not necessarily be placed into an off state as a result of the threshold voltage cancellation process.

In the driving method for an organic electroluminescence light emitting section according to the present embodiment including the preferred configurations, that is, in the driving method according to the present embodiment, the first voltage V₁_{_{—}}_{ON}, second voltage V₂_{_{—}}_{OFF} and third voltage V₃_{_{—}}_{ON} are successively applied to the gate electrode of the light emission control transistor. The voltages satisfy a relationship of |V₁_{_{—}}_{ON}−V₂_{_{—}}_{OFF}|<|V₃_{_{—}}_{ON}−V₂_{_{—}}_{OFF}|. The existing driving method corresponds to a form wherein, in both of the steps (b) and (d), when the light emission control transistor is to be placed into an on state, the third voltage V₃_{_{—}}_{ON} is applied. In contrast, in the driving method according to the present embodiment, the first voltage V₁_{_{—}}_{ON} is applied, in the threshold voltage cancellation process, to the gate electrode of the light emission control transistor before the light emission control transistor is placed into an off state. Then, as indicated by the expression given above, the absolute value of the potential difference between the first voltage V₁_{_{—}}_{ON} and the second voltage V₂_{_{—}}_{OFF} is smaller than the absolute value of the potential difference between the third voltage V₃_{_{—}}_{ON} and the second voltage V₂_{_{—}}_{OFF}. Consequently, the value of the time period ΔTₙ illustrated in FIGS. 20 and 21A can be set to a lower value. Thus, the difference of the potential variation at a node between the light emission control transistor T_{EL}_{_{—}}_{C} and the driving transistor T_{Drv} decreases, and deterioration of the uniformity in luminance of the display screen image described above can be suppressed. Further, while, upon light emission, the driving transistor supplies drain current I_{ds} defined by the expression (C) given hereinabove, if the gate voltage of the light emission control transistor connected in series to the driving transistor is proximate to the critical voltage, then the drain current I_{ds} of the value defined by the expression (C) given above cannot be supplied due to a restriction to the current capacity of the light emission control transistor, resulting in the possibility that the operation of the display apparatus may be hindered. Accordingly, even when the drain current I_{ds} defined by the expression (C) becomes a maximum value designed for the display apparatus, the light emission control transistor must be able to supply current without any trouble. According to the driving method of the present embodiment, since the voltage of the value with which a sufficient current capacity can be assured can be applied as the third voltage V₃_{_{—}}_{ON} to the gate of the driving transistor, operation of the display apparatus is not hindered at all.

In the driving method of the present embodiment, at the step (d), the image signal writing transistor is placed into an off state with a signal from the scanning line. The relationship in time between the timing at which the image signal writing transistor is placed into an off state and the time at which the third voltage is applied to the gate electrode of the light emission control transistor can be set suitably in accordance with the design of the organic EL display apparatus. For example, the third voltage may be applied to the gate electrode of the light emission control transistor immediately or after lapse of time after the image signal writing transistor is placed into an off state. Or, the image signal writing transistor may be placed into an off state after the third voltage is applied to the gate electrode of the light emission control transistor. It is to be noted that, in the form wherein the image signal writing transistor is placed into an off state after the third voltage is applied to the gate electrode of the light emission control transistor, a period within which both of the light emission control transistor and the image signal writing transistor exhibit an on state exists. Within the period just described, operation of the mobility correction process of raising the potential at the second node in response to the characteristic of the driving transistor is carried out. It is to be noted that also it is possible to carry out the step (c) in a state wherein the third voltage is applied to the gate electrode of the light emission control transistor. In this instance, the mobility correction process is carried out substantially together with the writing process.

In the driving method of the present embodiment including such various preferred configurations as described above, various circuits such as the scanning circuit and the image signal outputting circuit, various wiring lines such as the scanning lines and the data lines, the current supply section and the organic electroluminescence light emitting sections which may be hereinafter referred to simply as light emitting sections may each have a known configuration or structure. In particular, each light emitting section may include, for example, an anode electrode, a hole transport layer, a light emitting layer, an electron transport layer, a cathode electrode and so forth.

Although details of the driving circuit are hereinafter described, the driving circuit can be formed, for example, from any of a driving circuit (hereinafter referred to as 5Tr/1C driving circuit) composed of five transistors and one capacitor section, another driving circuit (hereinafter referred to as 4Tr/1C driving circuit) composed of four transistors and one capacitor section, and a further driving circuit (hereinafter referred to as 3Tr/1C driving circuit) composed of three transistors and one capacitor section.

The transistors of the driving circuit may be formed from n-channel thin film transistors (TFTs). As occasion demands, a p-channel field effect transistor may be used, for example, for the light emission control transistor, the image signal writing transistor and so forth. Meanwhile, the capacitor section may include an electrode, another electrode, and a dielectric layer or insulating layer sandwiched between the electrodes. The transistors and the capacitor section which form the driving circuit are formed in a certain plane, for example, formed on a support, and the light emitting section is formed above the transistors and the capacitor section of the driving circuit, for example, with an interlayer insulating layer interposed therebetween. The second one of the source/drain regions of the driving transistors is connected to the anode electrode provided in the light emitting section, for example, through a contact hole. It is to be noted that the transistors may be formed on a semiconductor substrate or the like.

In summary, with the driving method, the first voltage V₁_{_{—}}_{ON}, second voltage V₂_{_{—}}_{OFF} and third voltage V₃_{_{—}}_{ON} are successively applied to the gate electrode of the light emission control transistor. The voltages satisfy the relationship of |V₁_{_{—}}_{ON}−V₂_{_{—}}_{OFF}|<|V₃_{_{—}}_{ON}−V₂_{_{—}}_{OFF}|. Consequently, the value of the time period ΔTₙ illustrated in FIGS. 20 and 21A can be set to a lower value, and therefore, the difference of the potential variation at the node between the light emission control transistor T_{EL}_{_{—}}_{C} and the driving transistor T_{Drv} decreases. Accordingly, since also the difference in potential variation at the second node caused by electrostatic coupling by parasitic capacitance and so forth is suppressed, deterioration of the uniformity in luminance of the display screen image described above in the background of the invention can be suppressed. Further, while, upon light emission, the driving transistor supplies drain current I_{ds} defined by the expression (C) given hereinabove, if the gate voltage of the light emission control transistor connected in series to the driving transistor is proximate to the critical voltage, then there is the possibility that the operation of the display apparatus may be hindered by a restriction to the current capacity of the light emission control transistor. With the driving method of the present embodiment, since the voltage of the value with which a sufficient current capacity can be assured can be applied as the third voltage V₃_{_{—}}_{ON} to the gate of the driving transistor, operation of the display apparatus is not hindered at all.

### BRIEF DESCRIPTION OF THE DRAWINGS

FIG. 1 is a diagrammatic view schematically showing waveforms of a signal transmitted along a light emission controlling transistor control line of an organic EL display apparatus within several periods of time;

FIG. 2 is an equivalent circuit diagram of a driving circuit basically configured from 5 transistors and 1 capacitor section;

FIG. 3 is a block diagram of an organic EL display apparatus;

FIG. 4 is a timing chart illustrating driving of the driving circuit shown in FIG. 2;

FIG. 5 is a waveform diagram illustrating waveforms shown in FIG. 1 and waveforms shown at an upper portion of FIG. 4 for comparison;

FIGS. 6A to 6D and 7A to 7E are circuit diagrams illustrating on/off states and so forth of transistors which form the driving circuit shown in FIG. 2;

FIG. 8 is an equivalent circuit diagram of another driving circuit basically configured from 4 transistors and 1 capacitor section;

FIG. 9 is a block diagram of a display apparatus including the driving circuit shown in FIG. 8;

FIG. 10 is a timing chart illustrating driving of the driving circuit shown in FIG. 8;

FIGS. 11A to 11D and 12A to 12D are circuit diagrams illustrating on/off states and so forth of transistors which form the driving circuit shown in FIG. 8;

FIG. 13 is an equivalent circuit diagram of a further driving circuit basically configured from 3 transistors and 1 capacitor section;

FIG. 14 is a block diagram of a display apparatus including the driving circuit shown in FIG. 13;

FIG. 15 is a timing chart illustrating driving of the driving circuit shown in FIG. 13;

FIGS. 16A to 16D and 17A to 17E are circuit diagrams illustrating on/off states and so forth of transistors which form the driving circuit shown in FIG. 13;

FIG. 18 is a partial sectional view schematically showing part of an organic electroluminescence element;

FIG. 19 is a diagrammatic view schematically showing waveforms of a signal transmitted along a light emission controlling transistor control line of an organic EL display apparatus within several periods of time;

FIG. 20 is a waveform diagram illustrating waveforms shown in FIG. 19 and waveforms shown at an upper portion of FIG. 4 for comparison; and

FIGS. 21A and 21B are equivalent circuit diagrams illustrating operation of a driving circuit of the organic EL display apparatus of FIG. 19.

### DETAILED DESCRIPTION OF THE PREFERRED EMBODIMENTS

In the following, the present invention is described in detail with reference to preferred embodiments thereof.

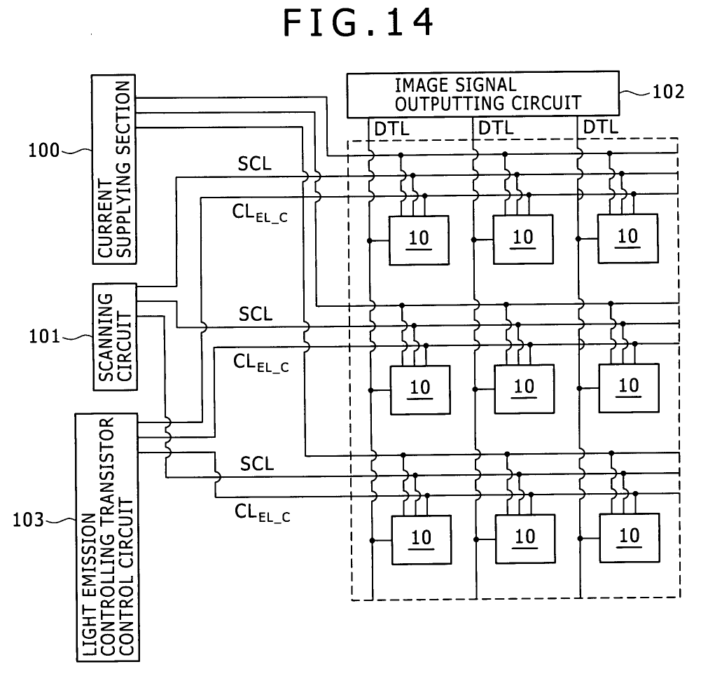

An organic EL display apparatus of the embodiment of the present invention includes, as seen in a block diagram of an organic EL circuit of FIG. 14:

(1) a scanning circuit 101;

(2) an image signal outputting circuit 102;

(3) a total of N×M organic electroluminescence elements 10 disposed in a two-dimensional matrix wherein N organic electroluminescence elements 10 are arrayed in a first direction and M organic electroluminescence elements 10 are arrayed in a second direction different from the first direction, particularly in a direction perpendicular to the first direction, and each including an organic electroluminescence light emitting section ELP and a driving circuit for driving the organic electroluminescence light emitting section ELP;

(4) M scanning lines SCL connected to the scanning circuit 101 and extending in the first direction;

(5) N data lines DTL connected to the image signal outputting circuit 102 and extending in the second direction; and

(6) a current supplying section 100.

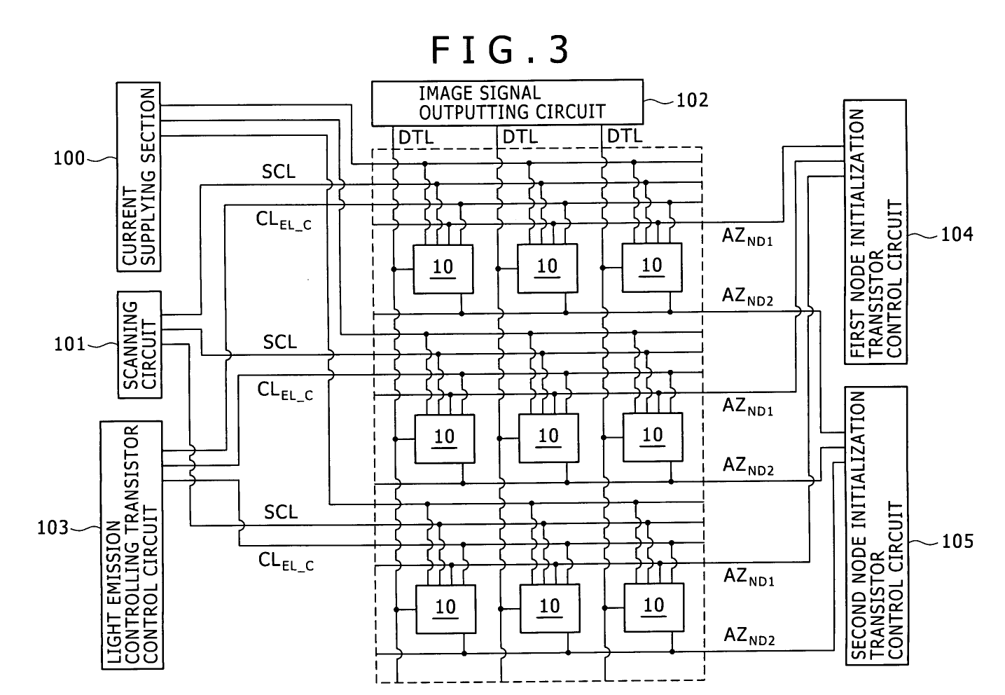

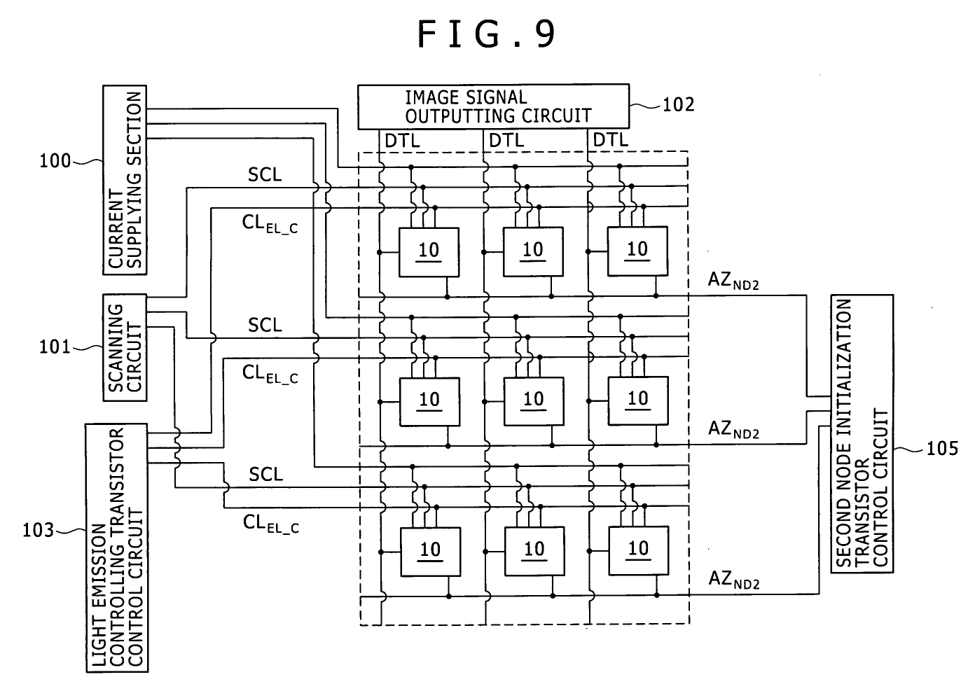

It is to be noted that, while 3×3 organic EL elements 10 are shown in FIG. 14 or in FIGS. 3 and 9, they are merely illustrative to the end.

As described hereinabove, each of the organic EL elements 10 includes a driving circuit and a light emitting section ELP. The light emitting section ELP has a known configuration and structure including, for example, an anode electrode, a hole transport layer, a light emitting layer, an electron transport layer and a cathode electrode. Further, the scanning circuit 101 is provided at one end of the scanning lines SCL. The scanning circuit 101, image signal outputting circuit 102, scanning lines SCL, data lines DTL and current supplying section 100 may individually have a known configuration and structure.

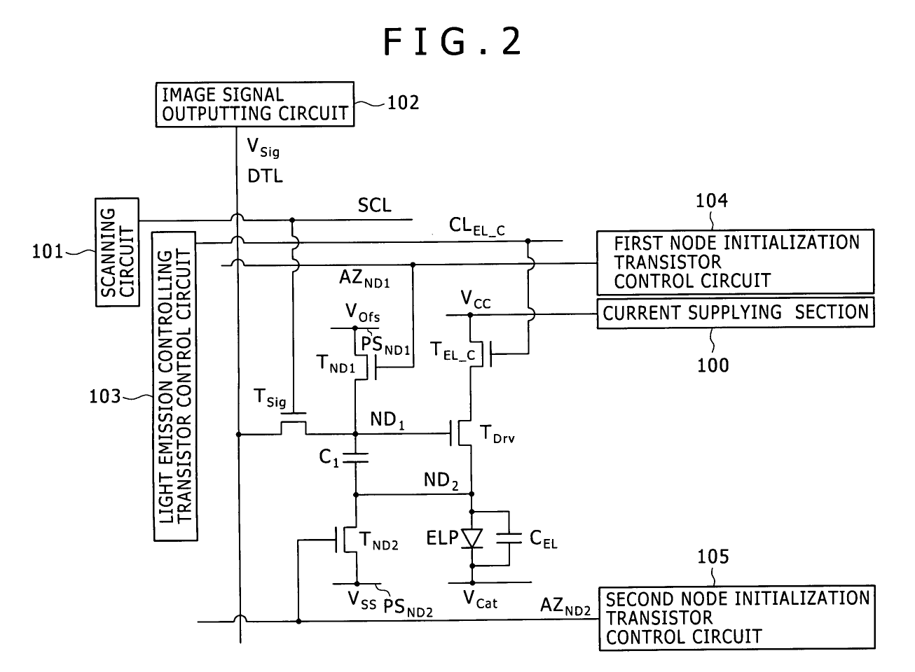

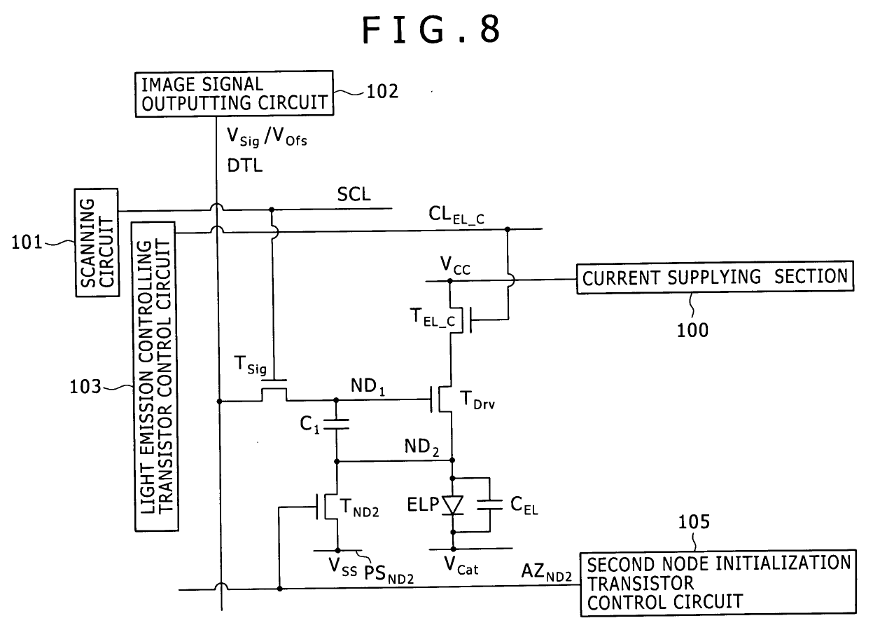

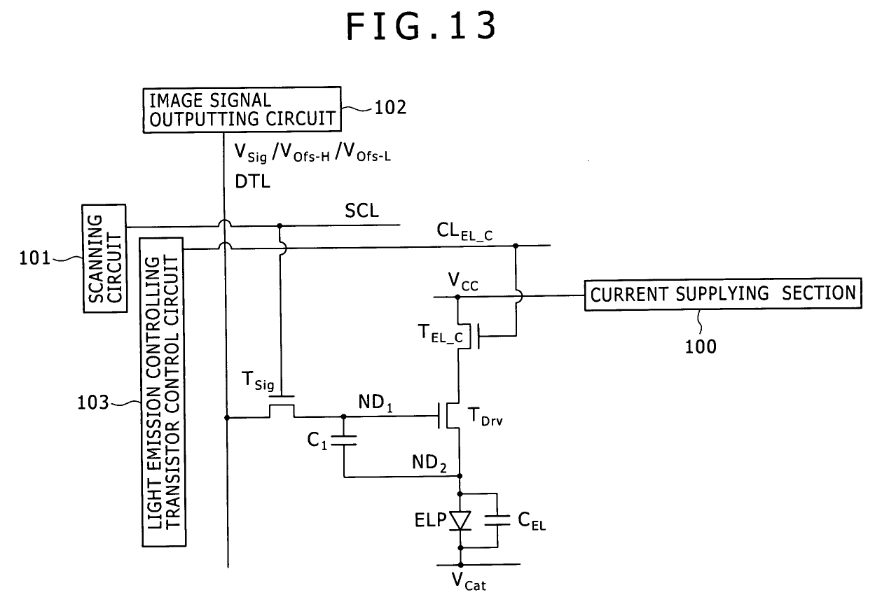

The driving circuit is basically configured as a 3Tr/1C driving circuit including three transistors and one capacitor section C₁. In particular, referring to FIG. 13, the driving circuit in the embodiment includes (A) a driving transistor T_{Drv}, (B) an image signal writing transistor T_{Sig}, (C) a light emission control circuit T_{EL}_{_{—}}_{C}, and (D) a capacitor section C₁ having a pair of electrodes. It is to be noted that the driving circuit shown in FIG. 8 is formed as a 4Tr/1C driving circuit which additionally includes (E) a second node initialization transistor T_{ND2}. Further, the driving circuit shown in FIG. 2 is formed as a 5Tr/1C driving circuit which further includes, in addition to the second node initialization transistor T_{ND2}, (F) a first node initialization transistor T_{ND1}.

Each of the driving transistor T_{Drv}, image signal writing transistor T_{Sig}, light emission control circuit T_{EL}_{_{—}}_{C}, first node initialization transistor T_{ND1} and second node initialization transistor T_{ND2} mentioned above is formed as an n-channel TFT having source/drain regions, a channel formation region and a gate electrode. This similarly applies also to the other embodiments of the present invention hereinafter described. It is to be noted that each of the image signal writing transistor T_{Sig}, light emission control circuit T_{EL}_{_{—}}_{C}, first node initialization transistor T_{ND1} and second node initialization transistor T_{ND2} may otherwise be formed from a p-channel TFT.

Here, the driving transistor T_{Drv} is configured such that:

(A-1) a first one of the source/drain regions is connected to a second one of the source/drain regions of the light emission control transistor _{TEL}_{_{—}}_{C}; that

(A-2) a second one of the source/drain regions is connected to an anode electrode provided in the organic electroluminescence light emitting section ELP and is connected to a first one of the electrodes of the capacitor section C₁ to form a second node ND₂; and that

(A-3) the gate electrode is connected to a second one of the source/drain regions of the image signal writing transistor T_{Sig} and is connected to a second one of the electrodes of the capacitor section C₁ to form a first node ND₁.

Meanwhile, the image signal writing transistor T_{Sig} is configured such that:

(B-1) a first one of the source/drain regions is connected to a data line DTL; and that

(B-2) the gate electrode is connected to a scanning line SCL. The scanning line SCL is connected to the scanning circuit 101.

Further, the light emission control transistor T_{Sig} is configured such that:

(C-1) a first one of the source/drain regions is connected to a current supplying section 100; and that

(C-2) the gate electrode is connected to a light emission control transistor control line CL_{EL}_{_{—}}_{C}. The light emission control transistor control line CL_{EL}_{_{—}}_{C} is connected to the light emission control transistor control circuit 103.

It is to be noted that the 4Tr/1C driving circuit shown in FIG. 8 and the 5Tr/1C driving circuit shown in FIG. 2 further includes a second node initialization transistor T_{ND2}. The second node initialization transistor T_{ND2} is configured such that

(E-1) a first one of the source/drain regions is connected to a second node initialization voltage supply line PS_{ND2}; that

(E-2) a second one of the source/drain regions is connected to the second node ND₂; and that

(E-3) the gate electrode is connected to a second node initialization transistor control line AZ_{ND2}. The second node initialization transistor control line AZ_{ND2} is connected to the second node initialization transistor control circuit 105.

Further, the 5Tr/1C driving circuit shown in FIG. 2 further includes a first node initialization transistor T_{ND1}. The first node initialization transistor T_{ND1} is configured such that

(F-1) a first one of the source/drain regions is connected to a first node initialization voltage supply line PS_{ND1}; that

(F-2) a second one of the source/drain regions is connected to the first node ND₁; and that

(F-3) the gate electrode is connected to a first node initialization control line AZ_{ND1}. The first node initialization control line AZ_{ND1} is connected to the first node initialization transistor control circuit 104.

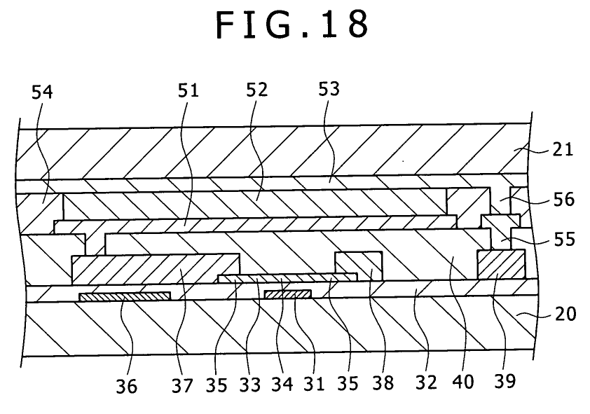

As seen from FIG. 18 which shows a schematic cross section of part of an organic EL element, the transistors and the capacitor section C₁ which form a driving circuit are formed on a support 20. Meanwhile, the light emitting section ELP is formed above the transistors and the capacitor sections C₁, which form the driving circuit, with an interlayer insulating layer 40 interposed therebetween. Meanwhile, the source region of the driving transistor T_{Drv} is connected to the anode electrode provided on the light emitting section ELP through a contact hole. It is to be noted that FIG. 18 only shows the driving transistor T_{Drv}. The transistors other than the driving transistor T_{Drv} are hidden and cannot be seen.

More specifically, the driving transistor T_{Drv} includes a gate electrode 31, a gate insulating layer 32, a semiconductor layer 33, source/drain regions 35 provided on the semiconductor layer 33, and a channel formation region 34 provided by a portion of a semiconductor layer 33 between the source/drain regions 35. Meanwhile, the capacitor section C₁ includes an electrode 36, a dielectric layer formed from an extension of the gate insulating layer 32, and another electrode 37 which corresponds to a second node ND₂. The gate electrode 31, part of the gate insulating layer 32 and the electrode 36 which forms the capacitor section C₁ are formed on a substrate 20. One of the source/drain regions 35 of the driving transistor T_{Drv} is connected to a wiring line 38 while the other one of the source/drain regions 35 is connected to the electrode 37 which corresponds to the second node ND₂. The driving transistor T_{Drv}, capacitor section C₁ and so forth are covered with the interlayer insulating layer 40. A light emitting section ELP is provided on the interlayer insulating layer 40 and includes an anode electrode 51, a hole transport layer, a light emitting layer, an electron transport layer and a cathode electrode 53. It is to be noted that, in FIG. 18, the hole transport layer, light emitting layer and electron transport layer are represented by one layer 52. On a portion of the interlayer insulating layer 40 on which the light emitting section ELP is not provided, a second interlayer insulating layer 54 is provided, and a substrate 21 is disposed on the second interlayer insulating layer 54 and the cathode electrode 53 such that light emitted from the light emitting layer is emitted to the outside through the substrate 21. It is to be noted that the electrode 37 or second node ND₂ and the anode electrode 51 are connected to each other through a contact hole formed in the interlayer insulating layer 40. Further, the cathode electrode 53 is connected to a wiring line 39 provided on the extension of the gate insulating layer 32 through contact holes 56 and 55 formed in the second interlayer insulating layer 54 and the interlayer insulating layer 40, respectively.

The organic EL display apparatus and the configuration of the driving circuit for driving the light emitting section ELP to which the present embodiment is applied are described above.

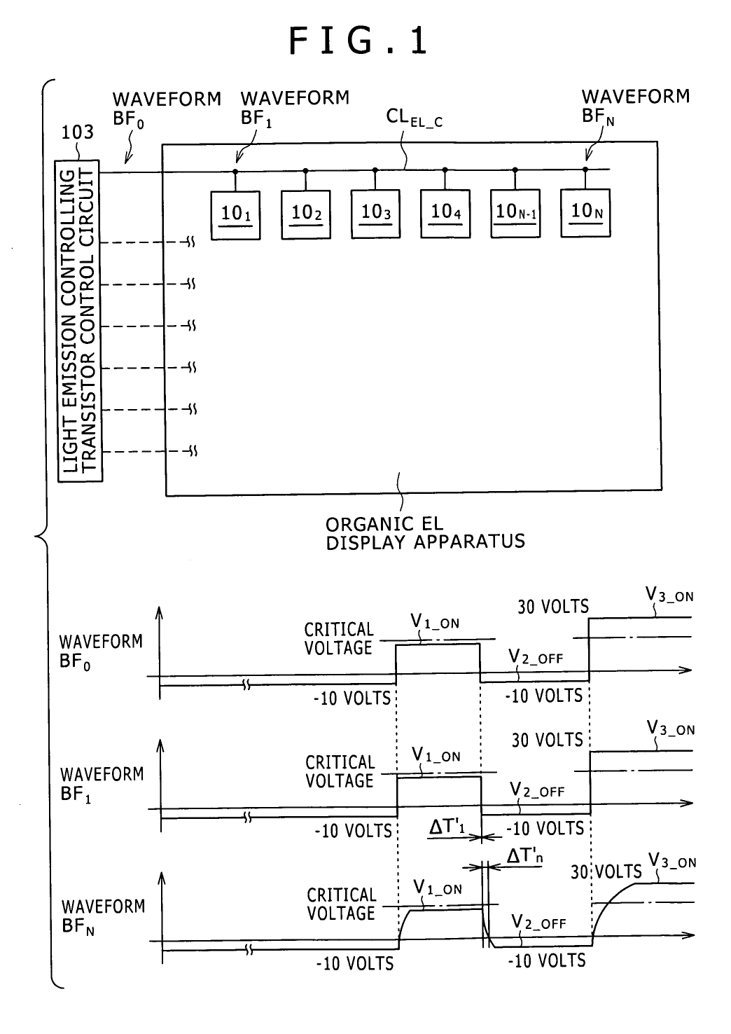

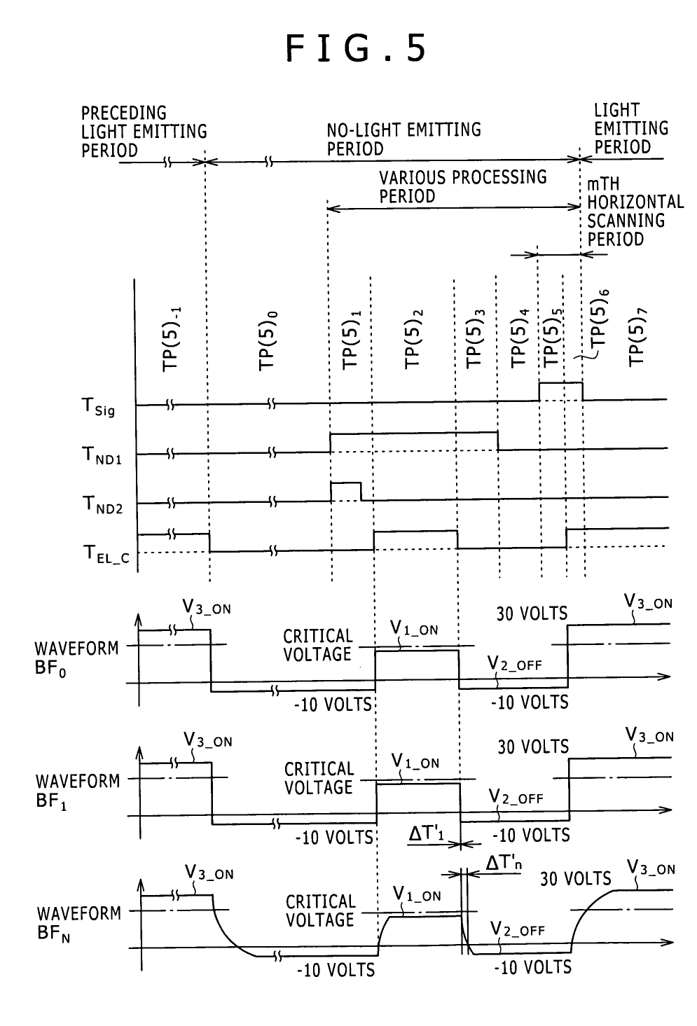

As seen from FIGS. 1 and 5, according to the driving method to which the present embodiment is applied, a voltage indicated by waveforms BF₀ to BF_{N} and composed of a first voltage V₁_{_{—}}_{ON}, a second voltage V₂_{_{—}}_{OFF} and a third voltage V₃_{_{—}}_{ON} is applied from the light emission control transistor control line CL_{EL}_{_{—}}_{C} to each organic EL element 10. The existing driving method corresponds to a form wherein the third voltage V₃_{_{—}}_{ON} and the second voltage V₂_{_{—}}_{OFF} are successively applied to the gate electrode of the light emission control circuit T_{EL}_{_{—}}_{C}. According to the driving method of the embodiment, when a threshold voltage cancellation process is carried out, the first voltage V₁_{_{—}}_{ON} is applied to the gate of the light emission control circuit T_{EL}_{_{—}}_{C} before it is placed into an off state. Further, the voltages mentioned satisfy a relationship of |V₁_{_{—}}_{ON}−V₂_{_{—}}_{OFF}|<|V₃_{_{—}}_{ON}−V₂_{_{—}}_{OFF}|.

Although the driving method according to the embodiment is described below, for the convenience of comparison with operation of the driving circuit described in the background of the invention hereinabove, operation of the 5Tr/1C driving circuit shown in FIG. 2 is described.

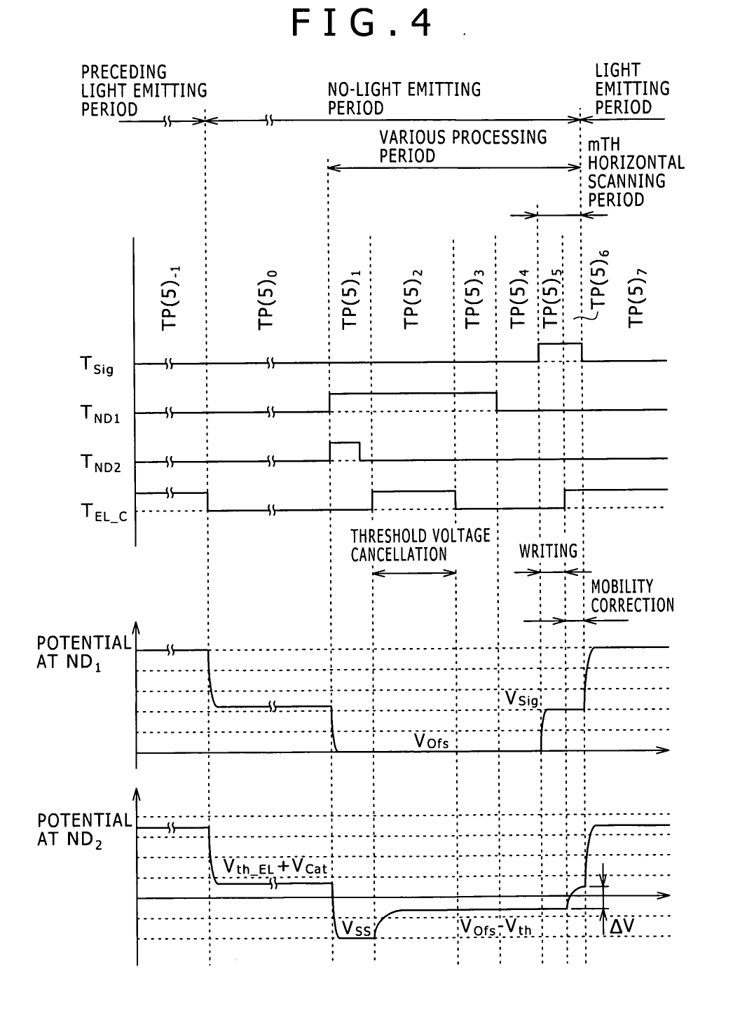

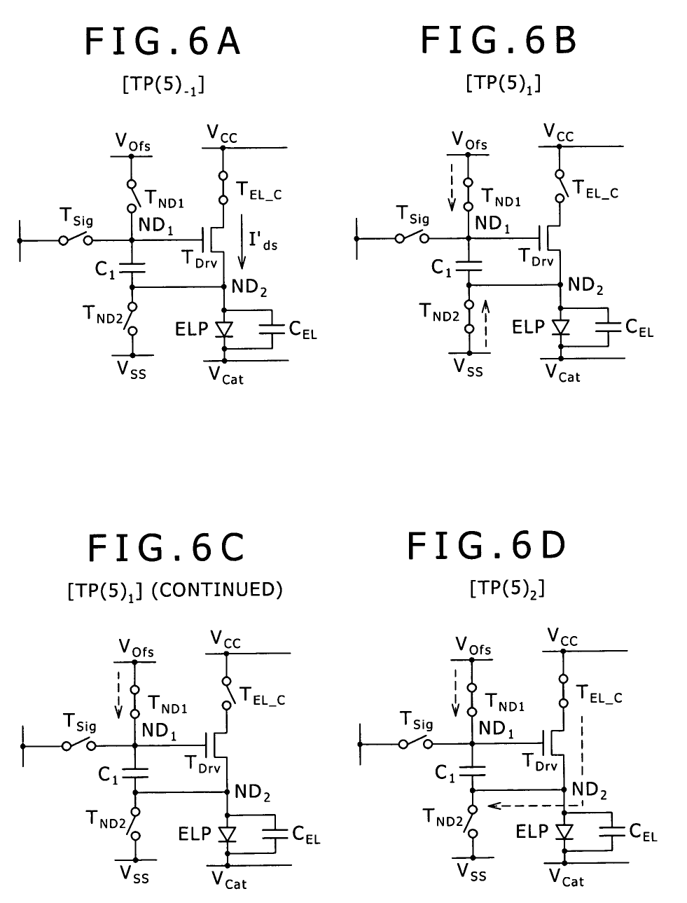

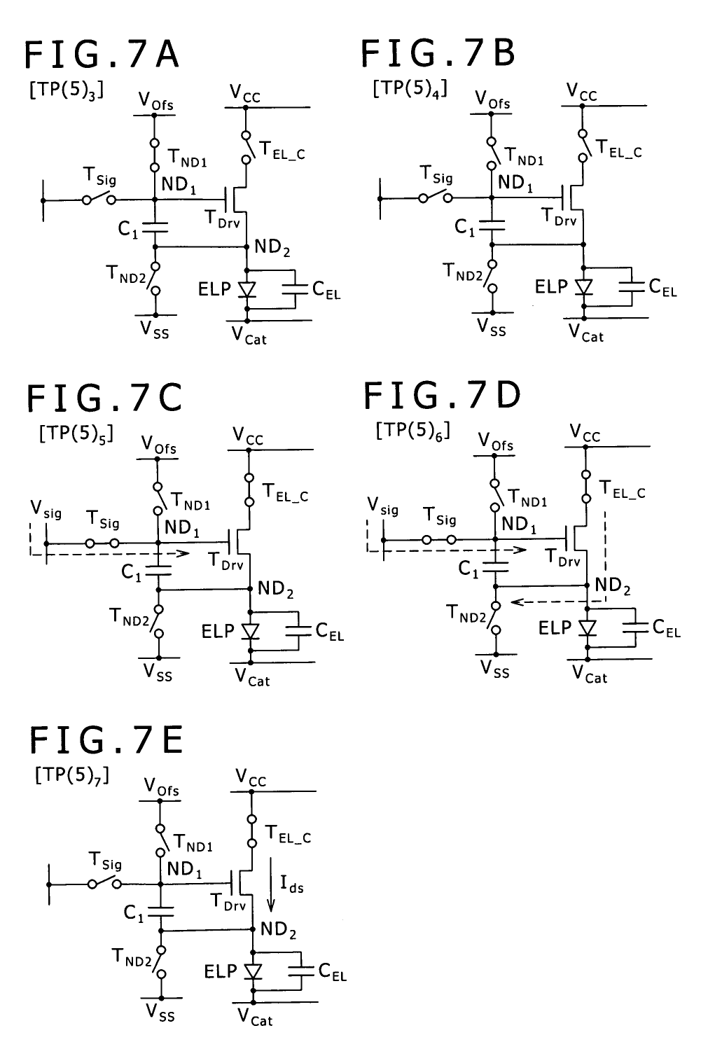

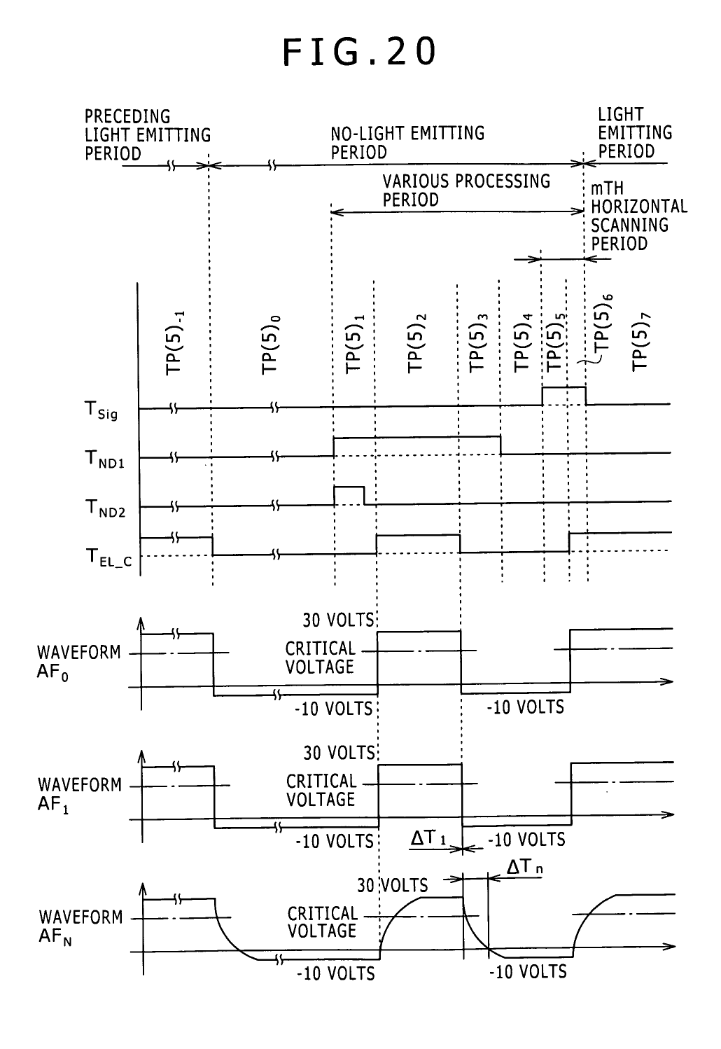

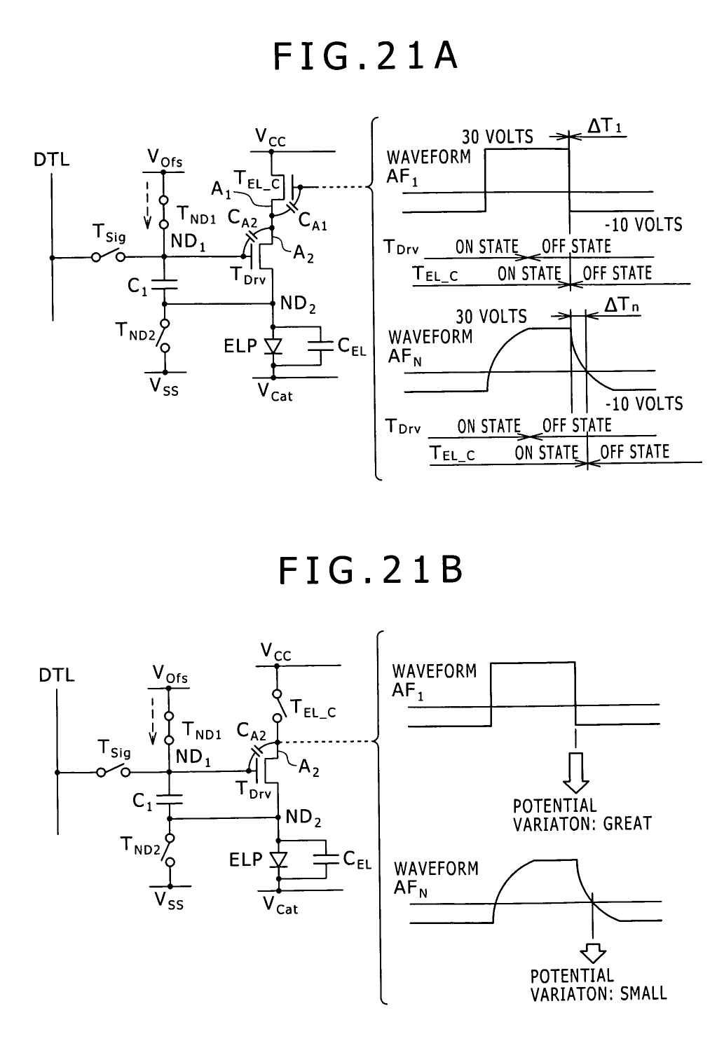

FIG. 1 schematically illustrates the waveforms BF₀, BF₁ and B_{FN} of a signal transmitted along a light emission control transistor control line CL_{EL}_{_{—}}_{C} of the organic EL display apparatus within periods of [period−TP(5)₂] to [period−TP(5)₇] illustrated in FIG. 4 in the driving method of the present embodiment. An equivalent circuit diagram of the 5Tr/1C driving circuit is shown in FIG. 2; a block diagram of the organic EL display apparatus is shown in FIG. 3; and a timing chart in driving of the 5Tr/1C driving circuit is shown in FIG. 4. FIG. 5 corresponds to FIG. 20 which is referred to in the description of the background of the invention hereinabove and shows the waveforms BF₀, BF₁ and B_{FN} shown in FIG. 1 and waveforms shown at an upper portion of the timing chart of FIG. 4. Further, on/off states and so forth of transistors of the 5Tr/1C driving circuit are schematically illustrated in FIGS. 6A to 6D and 7A to 7E.

The driving method of the present embodiment includes, as briefly described in the background of the invention hereinabove, the steps of:

(a) carrying out a preprocess of applying a first node initialization voltage to the first node ND₁ and applying a second node initialization voltage to the second node ND₂ so that a potential difference between the first and second nodes ND₁ and ND₂ exceeds a threshold voltage Vₜₕ of the driving transistor T_{Drv} and a potential difference between the second node ND₂ and a cathode electrode of the light emitting section ELP does not exceed a threshold voltage V_{th-EL} of the light emitting section ELP;

(b) carrying out a threshold voltage cancellation process for varying the potential at the second node ND₂ toward a potential of the difference of the threshold voltage Vₜₕ of the driving transistor T_{Drv} from the potential at the first node ND₁ while the potential at the first node ND₁ is maintained;

(c) carrying out a wiring process of applying an image signal from the data line DTL to the first node ND₁ through the image signal writing transistor T_{Sig} which is placed into an on state with a signal from the scanning line SCL; and

(d) placing the image signal writing transistor T_{Sig} into an off state with a signal from the scanning line SCL to place the first node ND₁ into a floating state and supplying current corresponding to the value of the potential difference between the first node ND₁ and the second node ND₂ from the current supplying section 100 to the organic electroluminescence light emitting section ELP through the light emission control transistor T_{EL}_{_{—}}_{C} and the driving transistor T_{Drv} to drive the light emitting section ELP.

It is to be noted that, in order to facilitate understanding of the present embodiment, details of the step (a) and the step (c) described above are hereinafter described with reference to FIGS. 4 and 6A to 6C.

For the convenience of description, it is assumed that, in the following description, operation of the light emission control circuit T_{EL}_{_{—}}_{C} changes over from that in a linear region to that in an unsaturated region across 20 volts of the voltage to the gate electrode of the light emission control circuit T_{EL}_{_{—}}_{C}.

As described in the summary of the invention hereinabove, a threshold voltage cancellation process is carried out within, before and after the [period−TP(5)₂] illustrated in FIG. 4. In the existing driving method, the waveform AF₀ of a signal of the light emission control transistor control circuit 103 is a rectangular waveform having two values including a voltage such as, for example, 30 volts for placing the light emission control circuit T_{EL}_{_{—}}_{C} into an on state and another voltage such as, for example, −10 volts for placing the light emission control circuit T_{EL}_{_{—}}_{C} into an off state as seen in FIG. 20.

On the other hand, in the present embodiment, the step (b) for carrying out the threshold voltage cancellation process includes two steps (b-1) and (b-2) described below.

[Step (b-1)]

At a starting timing of the [period−TP(5)₂], the light emission control transistor control circuit 103 operates to apply the first voltage V₁_{_{—}}_{ON} such as, for example, 18 volts for placing the light emission control circuit T_{EL}_{_{—}}_{C} into an on state to the gate electrode of the light emission control circuit T_{EL}_{_{—}}_{C} through the light emission control transistor control line CL_{EL}_{_{—}}_{C}. Then, through the light emission control circuit T_{EL}_{_{—}}_{C} in the on state, one of the source/drain regions of the driving transistor T_{Drv} is electrically connected to the current supplying section 100 so that the potential at the one of the source/drain regions of the driving transistor T_{Drv} is set higher than the potential at the second node ND₂ at the step (a) described hereinabove. More particularly, a voltage higher than the sum voltage of the threshold voltage Vₜₕ of the driving transistor T_{Drv} and the potential at the second node ND₂ at the step (a) described hereinabove is applied from the current supplying section 100 to the one of the source/drain regions of the driving transistor T_{Drv}. As a result, the potential at the second node ND₂ varies toward the potential of the difference of the threshold voltage Vₜₕ of the driving transistor T_{Drv} from the potential at the first node ND₁.

[Step (b-2)]

Then, at a starting timing of the [period−TP(5)₃], the light emission control transistor control circuit 103 operates to apply the second voltage V₂_{_{—}}_{OFF} such as, for example, −10 volts for placing the light emission control circuit T_{EL}_{_{—}}_{C} into an off state to the gate electrode of the light emission control circuit T_{EL}_{_{—}}_{C} through the light emission control transistor control line CL_{EL}_{_{—}}_{C}.

Then, at the step (d), the third voltage V₃_{_{—}}_{ON} such as, for example, 30 volts for placing the light emission control circuit T_{EL}_{_{—}}_{C} into an on state is applied to the gate electrode of the light emission control circuit T_{EL}_{_{—}}_{C} through the light emission control transistor control line CL_{EL}_{_{—}}_{C}. Then, within the [period−TP(5)₇], one of the source/drain regions of the driving transistor T_{Drv} is electrically connected to the current supplying section 100 through the light emission control circuit T_{EL}_{_{—}}_{C} in the on state so that current corresponding to the value of the potential difference between the first node ND₁ and the second node ND₂ is supplied to the light emitting section ELP. It is to be noted that, in the present embodiment, the third voltage V₃_{_{—}}_{ON} begins to be applied to the gate electrode of the light emission control circuit T_{EL}_{_{—}}_{C} before the first node ND₁ is placed into a floating state to carry out also the mobility correction process described hereinabove.

Details of operation of the driving circuit at the steps (b-1) and (b-2) and the step (d) are hereinafter described with reference to FIGS. 4, 6D and 7A to 7E.

The waveform BF₀ of the signal of the light emission control transistor control circuit 103 has the three values of the first voltage V₁_{_{—}}_{ON}, second voltage V₂_{_{—}}_{OFF} and third voltage V₃_{_{—}}_{ON} described hereinabove corresponding to the steps (b-1), (b-2) and (d) as seen in FIG. 5. The voltages have a relationship of |V₁_{_{—}}_{ON}−V₂_{_{—}}_{OFF}|<|V₃_{_{—}}_{ON}−V₂_{_{—}}_{OFF}|.

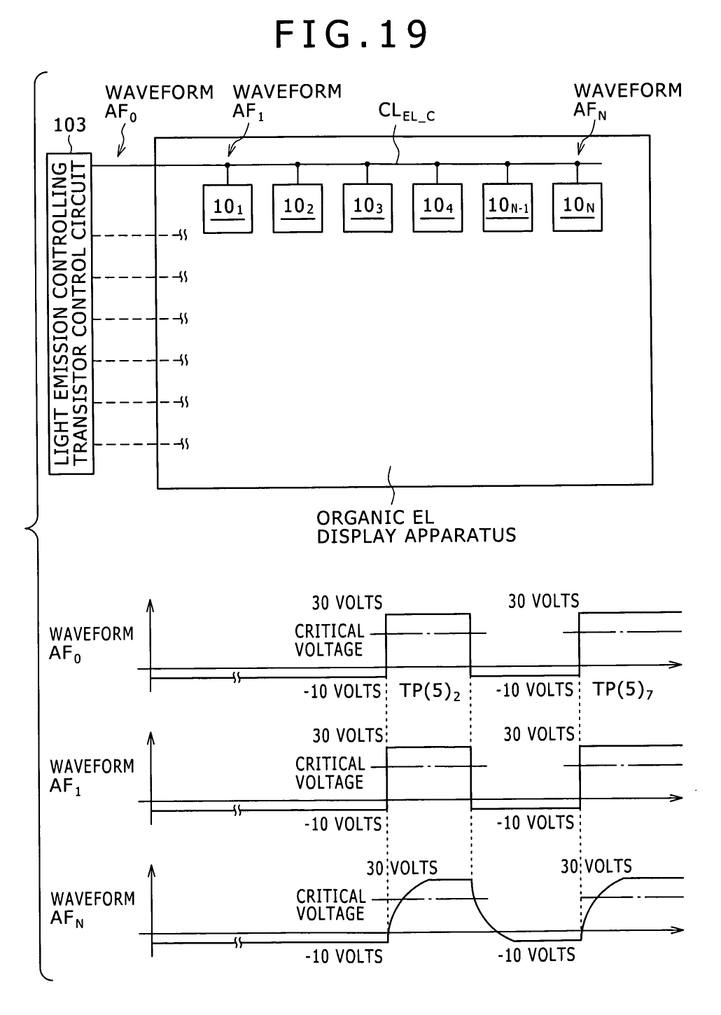

Similarly as in the description of the background of the invention hereinabove, also the waveform BF₀ is deformed and becomes dull at rising and falling edges thereof when it propagates along the light emission control transistor control line CL_{EL}_{_{—}}_{C}. The waveforms BF₁ and BF_{N} shown in FIGS. 1 and 5 indicate waveforms applied to the organic EL element 101 at the left end nearest to the light emission control transistor control circuit 103 and the organic EL element 10_{N} at the right end spaced most away from the light emission control transistor control circuit 103 similarly to the waveforms AF₁ and AF_{N} shown in FIGS. 19 and 20, respectively. Reference character ΔT₁′ shown at a lower portion of FIG. 1 and in FIG. 5 denotes a period of time until the light emission control circuit T_{EL}_{_{—}}_{C} changes over between an on state and an off state at a falling edge of the waveform BF₁. Ideally, the time period ΔT₁′ is zero. Meanwhile, reference character ΔTₙ′ denotes a period of time until the light emission control circuit T_{EL}_{_{—}}_{C} changes over between an on state and an off state at a falling edge of the waveform BF_{N}.

In the existing driving method, the voltage at the gate electrode of the light emission control circuit T_{EL}_{_{—}}_{C} before the light emission control circuit T_{EL}_{_{—}}_{C} is placed into an off state at the step (b) is 30 volts. On the other hand, in the driving method of the present embodiment, the voltage of the gate electrode of the light emission control circuit T_{EL}_{_{—}}_{C} before the light emission control circuit T_{EL}_{_{—}}_{C} is placed into an off state is V₁_{_{—}}_{ON} which is 18 volts. Accordingly, as seen in FIG. 5, the time period ΔTₙ′ at a falling edge of the waveform BF_{N} within the [period−TP(5)₂] is shorter than the time period ΔTₙ of FIG. 20. In particular, the time periods ΔT₁′ and ΔTₙ′ and the time periods ΔT₁ and ΔTₙ have a relationship of |ΔTₙ−ΔT₁|>|ΔTₙ′−ΔT₁′|. In other words, the difference in time period within which the potentials in the source/drain regions A₁ and A₂ are retained on the voltage V_{CC} side at a falling edge of the waveform decreases. As a result, the difference in potential at the node between the light emission control circuit T_{EL}_{_{—}}_{C} and the driving transistor T_{Drv} of the organic EL element 10₁ at the left end and the variation in potential at the node between the light emission control circuit T_{EL}_{_{—}}_{C} and the driving transistor T_{Drv} of the organic EL element 10_{N} at the right end decreases.

As described in the description of the summary of the invention hereinabove, the potential variation at the node between the light emission control circuit T_{EL}_{_{—}}_{C} and the driving transistor T_{Drv} propagates finally to the second node ND₂. Then, as a result of such propagation of the potential variation, the value of the drain current within the [period−TP(5)₇] varies. In the present embodiment, the difference in potential variation between the organic EL element 10₁ at the left end nearest to the light emission controlling transistor control circuit 103 and the organic EL element 10_{N} at the right end displaced most from the light emission controlling transistor control circuit 103 decreases. This similarly applied also to the other organic EL elements 10. Accordingly, the variation of the value of the drain current within the [period−TP(5)₇] decreases, and deterioration of the uniformity in luminance of the display screen image can be suppressed.

Further, as seen in FIGS. 5 and 20, within the [period−TP(5)₇], in order to turn on the light emission control circuit T_{EL}_{_{—}}_{C}, the third voltage V₃_{_{—}}_{ON} of a value similar to that in the existing driving method is applied to the gate electrode of the light emission control circuit T_{EL}_{_{—}}_{C}. Accordingly, the current capacity of the light emission controlling transistor at the step (d) comes to have a similar value to that in the existing driving method, and no influence is had on the emitted light luminance of the light emitting section.

The driving method of the present embodiment is described above.

In the following the 5Tr/1C driving circuit, 4Tr/1C driving circuit, 3Tr/1C driving circuit and the light emitting section ELP which uses such driving circuits are described.

The organic EL display apparatus includes N/3×M pixels arrayed in a two-dimensional matrix. However, in the following description, it is assumed that one pixel is composed of three sub pixels including a red light emitting sub pixel for emitting red light, a green light emitting sub pixel for emitting green light and a blue light emitting sub pixel for emitting blue light. Further, the organic EL elements 10 which form the pixels are line-sequentially driven, and the display frame rate is FR times/second. In particular, the organic EL elements 10 which form the N/3 pixels, that is, N sub pixels, arrayed in the mth row where m=1, 2, 3, . . . , M are driven at the same time. In other words, in the organic EL elements 10 which form one row, the light emission/no-light emission timings are controlled in a unit of a row to which the organic EL elements 10 belong. It is to be noted that a process, hereinafter referred to as a simultaneous writing process, of writing an image signal into pixels which form one row may be a process of writing an image signal at the same time into all pixels, or a process, hereinafter referred to merely as a sequential writing process, of writing an image signal sequentially into the pixels. One of the writing processes to be actually applied may be suitably selected based on the configuration of the driving circuit.

Here, driving and operation relating to an organic EL element 10 which forms one sub pixel in a pixel positioned at the mth row and the nth column where n=1, 2, 3, . . . , N as a representative is described. Such a sub pixel or organic EL element 10 as just mentioned is hereinafter referred to as (n, m)th sub pixel or (n, m)th organic EL element 10. Various processes including a threshold voltage cancellation process, a writing process and a mobility correction process hereinafter described are carried out before a horizontal scanning period for the organic EL elements 10 arrayed in the mth row, that is, an mth horizontal scanning period, ends. It is to be noted that it is necessary for the writing process and the mobility correction process to be carried out within the mth horizontal scanning period. On the other hand, depending upon the type of the driving circuit, the threshold voltage cancellation process and a preprocess for the threshold voltage cancellation process may be carried out preceding to the mth horizontal scanning period.

Then, after all of the processes mentioned above end, the light emitting sections of the organic EL elements 10 arrayed in the mth row are driven to emit light. It is to be noted that the light emitting sections may emit light immediately after all of the processes described above end or may emit light after lapse of a predetermined period of time such as, for example, a horizontal scanning period for a predetermined number of rows elapses after all of the processes end. The predetermined period of time may be set suitably in accordance with the specifications of the organic EL display apparatus, the configuration of the driving circuit and so forth. It is to be noted that, in the following description, for the convenience of description, it is assumed that the light emitting sections emit light immediately after the processes end. Then, the light emission of the light emitting section which forms each of the organic EL elements 10 arrayed in the mth row continues until a point of time immediately before a horizontal scanning period for the organic EL elements 10 arrayed in the (m+m′)th row starts. Here, “m′” is determined depending upon the design specifications of the organic EL display apparatus. In particular, the light emission of the light emitting section which forms each of the organic EL elements 10 arrayed in the mth row of a certain display frame continues until the (m+m′−1)th row. Meanwhile, the light emitting section which forms each of the organic EL elements 10 arrayed in the mth row keeps its no-light emitting state from a starting point of the (m+m′)th horizontal scanning period to another point of time at which the writing process and the mobility correction process are completed within the mth horizontal period for a next display frame. Where the period described above within which no light is emitted, which may be hereinafter referred to merely as a no-light emitting period, is provided, fuzziness by an afterimage involved in active matrix driving is reduced, and consequently, the moving picture quality can be improved. However, the light emitting state/no-light emitting state of the sub pixels or organic EL elements 10 are not limited to the states described above. Further, the time length of a horizontal scanning period is less than 1/FR×1/M second. Where the value of m+m′ exceeds M, the excess of the horizontal scanning period is processed in a next display frame.

The term “one source/drain region” between two source/drain regions of one transistor is sometimes used so as to signify that one of the source/drain regions which is connected to a power supply section. Further, that a transistor is in an on state signifies a state wherein a channel is formed between the source/drain regions. In this instance, it does not matter whether or not current flows from one source/drain region to the other source/drain region of the transistor. On the other hand, that the transistor is in an off state signifies a state wherein no channel is formed between the source/drain regions. Further, that a source/drain region of a certain transistor is connected to a source/drain region of another transistor signifies a form wherein the source/drain region of the certain transistor and the source/drain region of the other transistor occupy the same region. Furthermore, the source/drain regions can be formed not only from a conductive substance such as polycrystalline silicon or amorphous silicon containing impurity but also from metal, alloy, conductive particles, a stack structure including such metal, alloy or conductive particles, or a layer formed from an organic material or conductive polymer. Further, in timing charts used in the following description, the length of the axis of abscissa indicative of a period, that is, the time length, is merely schematic but does not indicate the ratio in time length between different periods.

### [5Tr/1C Driving Circuit]

As described hereinabove, an equivalent circuit diagram of the 5Tr/1C driving circuit is shown in FIG. 2; a block diagram of the organic EL display apparatus is shown in FIG. 3; a timing chart in driving of the 5Tr/1C driving circuit is shown in FIG. 4; and on/off states of transistors of the 5Tr/1C driving circuit are schematically illustrated in FIGS. 6A to 6D and 7A to 7E.

Referring to FIGS. 2 to 4 and 7A to 7E, the 5Tr/1C driving circuit includes five transistors including an image signal writing transistor T_{Sig}, a driving transistor T_{Drv}, a light emission control transistor T_{EL}_{_{—}}_{C}, a first node initialization transistor T_{ND1}, a second node initialization transistor T_{ND2}, and further includes one capacitor section C₁.

### [Light Emission Control Transistor T_{EL}_{_{—}}_{C}]

One source/drain region of the light emission control transistor T_{EL}_{_{—}}_{C} is connected to a current supplying section 100 for supplying a voltage V_{CC} while the other source/drain of the light emission control transistor T_{EL}_{_{—}}_{C} is connected to one source/drain region of the driving transistor T_{Drv}. On/off operations of the light emission control transistor T_{EL}_{_{—}}_{C} are controlled by a light emission control transistor control line CL_{EL}_{_{—}}_{C} connected to the gate electrode of the light emission control transistor T_{EL}_{_{—}}_{C}. It is to be noted that the current supplying section 100 is provided so as to supply current to the light emitting section ELP of the organic EL element 10 to control light emission of the light emitting section ELP. Further, the light emission control transistor control line CL_{EL}_{_{—}}_{C} is connected to the light emission controlling transistor control circuit 103.

### [Driving Transistor T_{Drv}]

One source/drain region of the driving transistor T_{Drv} is connected to the other source/drain region of the light emission control transistor T_{EL}_{_{—}}_{C} as described hereinabove. In particular, one source/drain region of the driving transistor T_{Drv} is connected to the current supplying section 100 through the light emission control transistor T_{EL}_{_{—}}_{C}. Meanwhile, the other source/drain region of the driving transistor T_{Drv} is connected to
(1) the anode electrode of the light emitting section ELP,
(2) the other source/drain region of the second node initialization transistor T_{ND2}, and
(3) one of electrodes of the capacitor section C₁, and forms the second node ND₂. Meanwhile, the gate electrode of the driving transistor T_{Drv} is connected to
(1) the other source/drain region of the image signal writing transistor T_{Sig},
(2) the other source/drain region of the first node initialization transistor T_{ND1}, and
(3) the other electrode of the capacitor section C₁ and forms a first node ND₁.

When the organic EL element 10 is in a light emitting state, the driving transistor T_{Drv} is driven so as to supply drain current I_{ds} in accordance with the following expression (1):

I_{ds}=k·μ·(V_{gs}−Vₜₕ)² (1)

where
μ: effective mobility
L: channel length
W: channel width
V_{gs}: potential difference between the gate electrode and the other source/drain region which acts as a source region
Vₜₕ: threshold voltage
Cₒₓ: (relative dielectric constant of the gate insulating layer)×(dielectric constant of vacuum)/(thickness of the gate insulating layer)

k≡(½)·(W/L)·Cₒₓ

In the light emitting state of the organic EL element 10, one of the source/drain regions of the driving transistor T_{Drv} acts as a drain region while the other source/drain region acts as a source region. For the convenience of description, in the following description, the one source/drain region of the driving transistor T_{Drv} is sometimes referred to merely as a drain region and the other source/drain region is sometimes referred to merely as source region.

When the drain current Ids flows through the light emitting section ELP of the organic EL element 10, the light emitting section ELP of the organic EL element 10 emits light. Further, the light emitting state, that is, the luminance of the emitted light, of the light emitting section ELP of the organic EL element 10 is controlled by the magnitude of the value of the drain current Ids.

### [Image Signal Writing Transistor T_{Sig}]

The other source/drain region of the image signal writing transistor T_{Sig} is connected to the gate electrode of the driving transistor T_{Drv} as described hereinabove. Meanwhile, the one source/drain region of the image signal writing transistor T_{Sig} is connected to a data line DTL such that an image signal V_{Sig} for controlling the luminance of the light emitting section ELP is supplied from the image signal outputting circuit 102 to the one source/drain region through the data line DTL. It is to be noted that various signals or voltages such as a signal for precharge driving and various reference voltages may be supplied to the one source/drain region through the data line DTL. The on/off operations of the image signal writing transistor T_{Sig} are controlled by a scanning line SCL connected to the gate electrode of the image signal writing transistor T_{Sig}.

### [First Node Initialization Transistor T_{ND1}]

The other source/drain region of the first node initialization transistor T_{ND1} is connected to the gate electrode of the driving transistor T_{Drv} as described hereinabove. Meanwhile, a voltage V_{Ofs} for initializing the potential at the first node ND₁, that is, the potential at the gate electrode of the driving transistor T_{Drv}, is supplied to the one source/drain region of the first node initialization transistor T_{ND1}. On/off operations of the first node initialization transistor T_{ND1} are controlled by a first node initialization transistor control line AZ_{ND1} connected to the gate electrode of the first node initialization transistor T_{ND1}. The first node initialization transistor control line AZ_{ND1} is connected to a first node initialization transistor control circuit 104.

### [Second Node Initialization Transistor T_{ND2}]

The other source/drain region of the second node initialization transistor T_{ND2} is connected to the source region of the driving transistor T_{Drv}. Meanwhile, a voltage V_{SS} for initializing the potential at the second node ND₂, that is, the potential at the source region of the driving transistor T_{Drv}, is supplied to the one source/drain region of the second node initialization transistor T_{ND2}. Further, on/off operations of the second node initialization transistor T_{ND2} are controlled by a second node initialization transistor control line AZ_{ND2} connected to the gate electrode of the second node initialization transistor T_{ND2}. The second node initialization transistor control line AZ_{ND2} is connected to a second node initialization transistor control circuit 105.

### [Light Emitting Section ELP]

The anode electrode of the light emitting section ELP is connected to the source region of the driving transistor T_{Drv} as described above. Meanwhile, a voltage V_{Cat} is applied to the cathode electrode of the light emitting section ELP. The parasitic capacitance of the light emitting section ELP is represented by reference character C_{EL}. Further, the threshold voltage demanded for emission of light of the light emitting section ELP is represented by V_{th-EL}. In particular, the light emitting section ELP emits light if a voltage higher than the voltage V_{th-EL} is applied between the anode electrode and the cathode electrode of the light emitting section ELP.

While, in the following description, voltages or potentials having the values given below are applied, they are values for explanation to the end, but the values of the voltages or potentials are not restricted to the given values.
V_{Sig}: image signal for controlling the luminance of the light emitting section ELP

0 to 10 volts
V_{CC}: voltage of the current supplying section for controlling the light emission of the light emitting section ELP

20 volts
V_{Ofs}: voltage for initializing the potential at the gate electrode of the driving transistor T_{Drv}, i.e., potential at the first node ND₁

0 volt
V_{SS}: voltage for initializing the potential at the source region of the driving transistor T_{Drv}, i.e., potential at the second node ND₂

−10 volts
Vₜₕ: threshold voltage for the driving transistor T_{Drv}

3 volts
V_{Cat}: voltage applied to the gate electrode of the light emitting section ELP

0 volt
V_{th-EL}: threshold voltage of the light emitting section ELP

3 volts
V₁_{_{—}}_{ON}: first voltage for placing the light emitting control transistor into an on state

18 volts
V₂_{_{—}}_{OFF}: second voltage for placing the light emitting control transistor into an off state

−10 volts
V₃_{_{—}}_{ON}: third voltage for placing the light emitting control transistor into an on state

30 volts

In the following, operation of the 5Tr/1C driving circuit is described. It is to be noted that, although it is assumed that a light emitting state begins immediately after all of various processes including a threshold voltage cancellation process, a writing process and a mobility correction process are completed as described above, operation of the 5Tr/1C driving circuit is not limited to this. This similarly applies also to description of the 4Tr/1C driving circuit and the 3Tr/1C driving circuit.

It is to be noted that operation in the existing driving method is substantially similar to that described above except that the third voltage V₃_{_{—}}_{ON} is placed in place of the first voltage V₁_{_{—}}_{ON} at the step (b-1) within the [period−TP(5)₂].

### [Period−TP(5)₋₁] (Refer to FIGS. 4 and 6A)

This [period−TP(5)₋₁] is a period within which the (n, m)th organic EL element 10 remains in a light emitting state after various processes in a preceding operation cycle are completed as operation in the preceding display frame. In particular, drain current I′_{ds} based on an expression (5) hereinafter given flows through the light emitting section ELP of the organic EL element 10 which composes the (n, m)th sub pixel, and the luminance of the organic EL element 10 which forms the n, m)th sub pixel has a value corresponding to the drain current I′_{ds}. Here, the image signal writing transistor T_{Sig}, first node initialization transistor T_{ND1} and second node initialization transistor T_{ND2} are in an off state, and the light emitting control transistor T_{EL}_{_{—}}_{C} and the driving transistor T_{Drv} are in an on state. The light emitting state of the (n, m)th organic EL element 10 continues until a point of time at which a horizontal scanning period for the organic EL elements 10 arrayed in the (m+m′)th row starts. It is to be noted that another configuration may be applied wherein the periods of [period−TP(5)₁] to [period−TP(5)₄] are included in the mth horizontal scanning period in the currently displayed frame.

Within the periods of [period−TP(5)₀] to [period−TP(5)₄] illustrated in FIG. 4, operation until a point of time immediately before a next writing process is carried out after a light emitting state after completion of various processes in a preceding operation cycle ends is carried out. In particular, the periods of [period−TP(5)₀] to [period−TP(5)₄], have a time length, for example, beginning with a starting timing of the (m+m′)th horizontal scanning period in a preceding display frame to an ending timing of the (m−1)th horizontal scanning period in a current display frame. It is to be noted that periods of [period−TP(5)₁] to [period−TP(5)₄] may otherwise be included in the mth horizontal scanning period in the current display frame.

Then, within the periods of [period−TP(5)₀] to [period−TP(5)₄], the (n, m)th organic EL element 10 is in a no-light emitting state. In particular, within the periods of [period−TP(5)₀] to [period−TP(5)₁] and the periods of [period−TP(5)₃] to [period−TP(5)₄], since the light emission control transistor T_{EL}_{_{—}}_{C} is in an off state, the organic EL elements 10 does not emit light. It is to be noted that, within the [period−TP(5)₂], the light emission control transistor T_{EL}_{_{—}}_{C} exhibits an on state. However, within this period, the threshold voltage cancellation process hereinafter described is being carried out. Although detailed description is given in the description of the threshold voltage cancellation process, if it is assumed that an expression (2) hereinafter given is satisfied, then the organic EL element 10 does not emit light.

In the following, the periods of [period−TP(5)₀] to [period−TP(5)₄] are described first. It is to be noted that the starting timing of the [period−TP(5)₁] and the length of the periods of (period−TP(5)₁] to [period−TP(5)₄] may be set suitably in accordance with the design of the organic EL display apparatus.

### [Period−TP(5)₀]

As described hereinabove, within the [period−TP(5)₀], the (n, m)th organic EL element 10 is in a no-light emitting state. The image signal writing transistor T_{Sig}, first node initialization transistor T_{ND1} and second node initialization transistor T_{ND2} are in an off state. Meanwhile, at a point of time of transition from the [period−TP(5)₋₁] to the [period−TP(5)₀], the light emission control transistor T_{EL}_{_{—}}_{C} is placed into an off state. Therefore, the potential at the second node ND₂, that is, the source region of the driving transistor T_{Drv} or the anode electrode of the light emitting section ELP, drops to V_{th-EL}+V_{Cat}, and the light emitting section ELP is placed into a no-light emitting state. Further, also the potential at the first node ND₁ in a floating state, that is, at the gate electrode of the driving transistor T_{Drv}, drops in such a manner as to follow up the drop of the potential at the second node ND₂.

### [Period−TP(5)₁] (Refer to FIGS. 4, 5, 6B and 6C)

Within the period, the step (a), that is, the preprocess described hereinabove, is carried out. In the following, the preprocess is described in detail.

In particular, upon starting of the [period−TP(5)₁], the first node initialization transistor control circuit 104 and the second node initialization transistor control circuit 105 operate to set the first node initialization transistor control line AZ_{ND1} and the second node initialization transistor control line AZ_{ND2} to a high level to place the first node initialization transistor T_{ND1} and the second node initialization transistor T_{ND2} into an on state. It is to be noted that the first node initialization transistor T_{ND1} and the second node initialization transistor T_{ND2} may be placed into an on state simultaneously or the first node initialization transistor T_{ND1} may be placed into an on state first or conversely the second node initialization transistor T_{ND2} may be placed into an on state first. Then, the first node initialization voltage is applied from the first node initialization voltage supply line PS_{ND1} to the first node ND₁ through the first node initialization transistor T_{ND1} placed in an on state, and the second node initialization voltage is applied from the second node initialization voltage supply line PS_{ND2} to the second node ND₂ through the second node initialization transistor T_{ND2} placed in an on state.

As a result, the potential at the first node ND₁ becomes the voltage V_{Ofs} or 0 volt. Meanwhile, the potential at the second node ND₂ changes to the voltage V_{SS} of −10 volts. Since the potential difference between the first node ND₁ and the second node ND₂ is 10 volts and the threshold voltage Vₜₕ of the driving transistor T_{Drv} is 3 volts, the driving transistor T_{Drv} enters an on state. It is to be noted that the potential difference between the second node and the cathode electrode of the light emitting section ELP is −10 volts and do not exceed the threshold voltage V_{th-EL} of the light emitting section ELP.

Through the processes described above, the potential difference between the gate region and the source region of the driving transistor T_{Drv} becomes greater than the threshold voltage Vₜₕ and the driving transistor T_{Drv} exhibits an on state.

Prior to completion of the [period−TP(5)₁), the second node initialization transistor control circuit 105 operates to set the second node initialization transistor control line AZ_{ND2} to the low level to place the second node initialization transistor T_{ND2} into an off state.

Periods [period−TP(5)₂] to [period−TP(5)₃] (refer to FIGS. 4, 5, 6D and 7E)

Within the periods, the threshold voltage cancellation process provided by the step (b) described hereinabove, more particularly, by the steps (b-1) and (b-2), is carried out. In the following, the threshold voltage cancellation process is described in detail.

First, the step (b-1) described hereinabove is executed. In particular, while the on state of the first node initialization transistor T_{ND1} is maintained, at a starting timing of the [period−TP(5)₂], the light emission control transistor control circuit 103 operates to apply the first voltage V₁_{_{—}}_{ON} for placing the light emission control circuit T_{EL}_{_{—}}_{C} into an on state to the gate electrode of the light emission control circuit T_{EL}_{_{—}}_{C} through the light emission control transistor control line CL_{EL}_{_{—}}_{C} thereby to place the light emission control circuit T_{EL}_{_{—}}_{C} into an on state. As a result, while the potential at the first node ND₁ does not vary but maintains the voltage V_{Ofs}=0 volt, the potential at the second node ND₂ varies toward the potential of the difference of the threshold voltage Vₜₕ of the driving transistor T_{Drv} from the potential at the first node ND₁. In other words, the potential at the second node ND₂ in a floating state rises. Then, when the potential difference between the gate electrode and the source region of the driving transistor T_{Drv} reaches the threshold voltage Vₜₕ, the driving transistor T_{Drv} enters an off state. In particular, the potential at the second node ND₂ approaches V_{Ofs}−Vₜₕ=−3 volts>V_{SS} and finally becomes equal to V_{Ofs}−Vₜₕ. Here, if the expression (2) given below is assured, that is, if the potentials are selected and determined so as to satisfy the expression (2), then the light emitting section ELP does not emit light.

(V_{Ofs}−Vₜₕ)<(V_{th-EL}+V_{cat}) (2)

Then, the process (b-2) described hereinabove is carried out. In particular, while the on state of the first node initialization transistor T_{ND1} is maintained, at an initial timing of the [period−TP(5)₃], the light emission control transistor control circuit 103 operates to apply the second voltage V₂_{_{—}}_{OFF} for placing the light emission control transistor T_{EL}_{_{—}}_{C} into an off state to the gate electrode of the light emission control transistor T_{EL}_{_{—}}_{C} through the light emission control transistor control line CL_{EL}_{_{—}}_{C}. The potential at the first node ND₁ does not vary but maintains the voltage V_{Ofs}=0 volt, and also the potential at the second node ND₂ in a floating state maintains substantially V_{Ofs}−Vₜₕ=−3 volts.

As described hereinabove, the potential at the second node ND₂ finally becomes equal to V_{Ofs}−Vₜₕ through the steps (b-1) and (b-2). In particular, the potential at the second node ND₂ depends only upon the threshold voltage Vₜₕ of the driving transistor T_{Drv} and the voltage V_{Ofs} for initializing the gate electrode of the driving transistor T_{Drv}. Therefore, the potential at the second node ND₂ is independent of the threshold voltage V_{th-EL} of the light emitting section ELP.

### [Period−TP(5)₄] (Refer to FIG. 7B)

Then, the first node initialization transistor control circuit 104 operates to set the first node initialization transistor control line AZ_{ND1} to the low level to place the first node initialization transistor T_{ND1} into an off state. The potentials at the first node ND₁ and the second node ND₂ do not substantially vary. Although actually a potential variation is caused by electrostatic coupling of parasitic capacitance or the like, normally it is possible to ignore the variation.

Now, operation within the periods of [period−TP(5)₅] to [period−TP(5)₇] is described. It is to be noted that, as hereinafter described, within the [period−TP(5)₅], the writing process is carried out, and within the [period−TP(5)₆], the mobility correction process is carried out. It is necessary for the processes mentioned to be executed within the mth horizontal scanning period as described hereinabove. It is assumed that a starting timing of the [period−TP(5)₅] and an ending timing of the [period−TP(5)₆] coincide with a starting timing and an ending timing of the mth horizontal scanning period, respectively, for the convenience of description.

### [Period−TP(5)₅] (Refer to FIGS. 4 and 7C)

Within this period, the step (c), that is, the writing process described hereinabove, is carried out in the following manner. In particular, while the off state of the first node initialization transistor T_{ND1}, second node initialization transistor T_{ND2} and light emission control circuit T_{EL}_{_{—}}_{C} is maintained, the image signal outputting circuit 102 operates to set the potential at the data line DTL to the image signal voltage V_{Sig} for controlling the luminance of the light emitting section ELP. Then, the scanning circuit 101 operates to set the scanning line SCL to the high level to place the image signal writing transistor T_{Sig} into an on state. As a result, the potential at the first node ND₁ rises to the image signal V_{Sig}.

Here, the capacitance of the capacitor section C₁ is c₁ and the capacitance of the parasitic capacitance C_{EL} is c_{EL}. Then, the parasitic capacitance between the gate electrode and the source region of the driving transistor T_{Drv} is represented by C_{gs}. When the potential at the gate electrode of the driving transistor T_{Drv} varies from the voltage V_{Ofs} to the image signal V_{Sig} (>V_{Ofs}), the potentials at the opposite ends of the capacitor section C₁, that is, the potentials at the first node ND₁ and the second node ND₂, vary in principle. In particular, charge based on the variation V_{Sig}−V_{Ofs} of the potential at the gate electrode of the driving transistor T_{Drv}, that is, at the first node ND₁, is distributed to the capacitor section C₁, the parasitic capacitance C_{EL} of the light emitting section ELP and the parasitic capacitance between the gate electrode and the source region of the driving transistor T_{Drv}. However, if the parasitic capacitance C_{EL} is sufficiently high when compared with the values c₁ and c_{gs}, then the variation of the potential in the source region of the driving transistor T_{Drv}, that is, at the second node ND₂, based on the variation V_{Sig}−V_{Ofs} of the potential at the gate electrode of the driving transistor T_{Drv}, is small. Generally, the capacitance value C_{EL} of the parasitic capacitance C_{EL} of the light emitting section ELP is higher than the capacitance value c₁ and the value c_{gs} of the parasitic capacitance of the driving transistor T_{Drv}. Therefore, for the convenience of description, except in special circumstances, the description is given without taking the potential variation at the second node ND₂, which is caused by the potential variation at the first node ND₁ into consideration. This similarly applies also to the other driving circuits. It is to be noted that also the timing chart for driving shown in FIG. 4 is illustrated without taking the potential variation at the second node ND₂ caused by the potential variation at the first node ND₁ into consideration. Where the potential at the gate electrode of the driving transistor T_{Drv}, that is, at the first node ND₁, is represented by V_{g} and the potential at the source region of the driving transistor T_{Drv}, that is, at the second node ND₂, by Vₛ, the values of the potentials V_{g} and Vₛ are given by the expression (3) below. Therefore, the potential difference between the first node ND₁ and the second node ND₂, that is, the potential difference V_{gs} between the gate voltage and the source region of the driving transistor T_{Drv}, can be represented by the following expression (3):

Vg=V_{Sig}

Vs≈V_{Ofs}−Vₜₕ

V_{gs}≈V_{Sig}−(V_{Ofs}−Vₜₕ) (3)

In particular, the potential difference V_{gs} obtained in the writing process for the driving transistor T_{Drv} relies only upon the image signal V_{Sig} for controlling the luminance of the light emitting section ELP, the threshold voltage Vₜₕ of the driving transistor T_{Drv}, and the voltage V_{Ofs} for initializing the gate electrode of the driving transistor T_{Drv}. Then, the potential difference V_{gs} is independent of the threshold voltage V_{th-EL} of the light emitting section ELP.

### [Period−TP(5)₆] (Refer to FIG. 7D)

Thereafter, correction of the potential in the source region of the driving transistor T_{Drv}, that is, at the second node ND₂, based on the magnitude of the mobility μ of the driving transistor T_{Drv}, that is, the mobility correction process, is carried out.

Generally, where the driving transistor T_{Drv} is formed from a polycrystalline silicon thin film transistor or the like, it cannot be avoided that a dispersion in the mobility μ occurs among transistors. Accordingly, even if the image signal V_{Sig} of an equal value is applied to the gate electrode of a plurality of driving transistors T_{Drv} among which the mobility μ is different, a difference appears between the drain current I_{ds} flowing through a driving transistor T_{Drv} having a high mobility μ and another driving transistor T_{Drv} having a low mobility μ. Then, if such a difference as just mentioned appears, then the uniformity of the screen image of the organic EL display apparatus is damaged.

Therefore, while the on state of the driving transistor T_{Drv} is maintained, the light emission control transistor control circuit 103 operates to apply the third voltage V₃_{_{—}}_{ON} for placing the light emission control circuit T_{EL}_{_{—}}_{C} into an on state to the gate electrode of the light emission control circuit T_{EL}_{_{—}}_{C} through the light emission control transistor control line CL_{EL}_{_{—}}_{C}. Then, after the predetermined time to elapses, the scanning circuit 101 operates to set the scanning line SCL to the low level to place the image signal writing transistor T_{Sig} into an off state thereby to place the first node ND₁, that is, the gate electrode of the driving transistor T_{Drv}, into a floating state. As a result, where the value of the mobility μ of the driving transistor T_{Drv} is high, the increasing amount ΔV or potential correction value of the potential in the source region of the driving transistor T_{Drv} becomes great, but where the value of the mobility μ of the driving transistor T_{Drv} is low, the increasing amount ΔV or potential correction value of the potential in the source region of the driving transistor T_{Drv} becomes small. Here, the potential difference V_{gs} between the gate electrode and the source region of the driving transistor T_{Drv} is given by the following expression obtained by transformation of the expression (3):

V_{gs}≈V_{Sig}−(V_{Ofs}−Vₜₕ)−ΔV (4)

It is to be noted that the total time t₀ of the predetermined time [period−TP(5)₆] within which the mobility correction process is carried out may be determined in advance as a design value upon designing of the organic EL display apparatus. Further, the total time t₀ of the [period−TP(5)₆] is determined so that the potential V_{Ofs}−Vₜₕ+ΔV in the source region of the driving transistor T_{Drv} at this time satisfies the following expression (2′). Then, also correction of the dispersion of the coefficient k (≡(½)·(W/L)·Cₒₓ) is carried out simultaneously by the mobility correction process.

V_{Ofs}−Vₜₕ+ΔV<V_{th-EL}+V_{Cat} (2′)

[Period−TP(5)₇] (refer to FIGS. 4, 5 and 7E)

By the operations described above, the threshold voltage cancellation process, writing process and mobility correction process are completed. Thereafter, within the [period−TP(5)₇], the step (d) described hereinabove is carried out in the following manner. In particular, the scanning circuit 101 operates to set the scanning line SCL to the low level to place the image signal writing transistor T_{Sig} into an off state thereby to place the first node ND₁, that is, the gate electrode of the driving transistor T_{Drv}, into a floating state. Then, in order to place the light emission control circuit T_{EL}_{_{—}}_{C} into an on state, the third voltage V₃_{_{—}}_{ON} is applied to the gate electrode of the light emission control circuit T_{EL}_{_{—}}_{C} through the light emission control transistor control line CL_{EL}_{_{—}}_{C}, and then the applied state of the third voltage V₃_{_{—}}_{ON} is maintained. Meanwhile, the drain region of the light emission control circuit T_{EL}_{_{—}}_{C} is maintained in a state wherein it is connected to the current supplying section 100 of the voltage V_{CC}, for example, of 20 volts for controlling light emission of the light emitting section ELP. As a result of the operations, the potential at the second node ND₂ rises.

Here, since the gate electrode of the driving transistor T_{Drv} is in a floating state as described above and besides the capacitor section C₁ exists, a phenomenon similar to that of a bootstrap circuit occurs with the gate electrode of the driving transistor T_{Drv}. Consequently, also the potential at the first node ND₁ rises. As a result, the potential difference V_{gs} between the gate electrode and the source region of the driving transistor T_{Drv} maintains the value of the expression (4).

Further, since the potential at the second node ND₂ rises and exceeds V_{th-EL}+V_{Cat}, the light emitting section ELP begins to emit light. At this time, since the current flowing through the light emitting section ELP is drain current I_{ds} which flows from the drain region to the source region of the driving transistor T_{Drv}, it can be represented by the expression (1). Here, from the expressions (1) and (4), the expression (1) can be transformed into the following expression (5):

I_{ds}=k·μ·(V_{Sig}−V_{Ofs}−ΔV)² (4)

Accordingly, where the voltage V_{Ofs} is set to 0 volt, the drain current I_{ds} flowing through the light emitting section ELP increases in proportion to the square of the value of the difference of the value of the voltage correction value ΔV for the second node ND₂, that is, for the source of the driving transistor T_{Drv}, arising from the mobility μ of the driving transistor T_{Drv} from the value of the image signal V_{Sig} for controlling the luminance of the light emitting section ELP. In other words, the drain current Ids flowing through the light emitting section ELP depends neither on the threshold voltage V_{th-EL} of the light emitting section ELP nor on the threshold voltage Vₜₕ of the driving transistor T_{Drv}. Consequently, the emitted light amount, that is, the luminance, of the light emitting section ELP is influenced neither by the threshold voltage V_{th-EL} of the light emitting section ELP nor by the threshold voltage Vₜₕ of the driving transistor T_{Drv}. Thus, the luminance of the (n, m)th organic EL element 10 has a value corresponding to the drain current I_{ds}.

Besides, since the potential correction value ΔV increases as the mobility μ of the driving transistor T_{Drv} increases, the value of the left side of the expression (4) decreases. Accordingly, even if the value of the mobility μ is high in the expression (5), the drain current I_{ds} can be corrected because the value of (V_{Sig}−V_{Ofs}−ΔV)² decreases. In other words, even if the driving transistor T_{Drv} has a different mobility μ, if the value of the image signal V_{Sig} is equal, the drain current I_{ds} becomes substantially equal, and consequently, the drain current I_{ds} flowing through the light emitting section ELP to control the luminance of the light emitting section ELP is uniformized. In other words, the dispersion of the luminance of the light emitting section arising from the dispersion of the mobility μ and hence the dispersion of the coefficient k can be corrected.

The light emitting state of the light emitting section ELP continues till the (m+m′−1)th horizontal scanning period. This point of time corresponds to the end of the [period−TP(5)₋₁].

The light emission operation of the organic EL element 10, that is, the (n, m)th sub pixel (organic EL element 10) is completed therewith.

Now, the 4Tr/1C driving circuit is described.

### [4Tr/1C Driving Circuit]

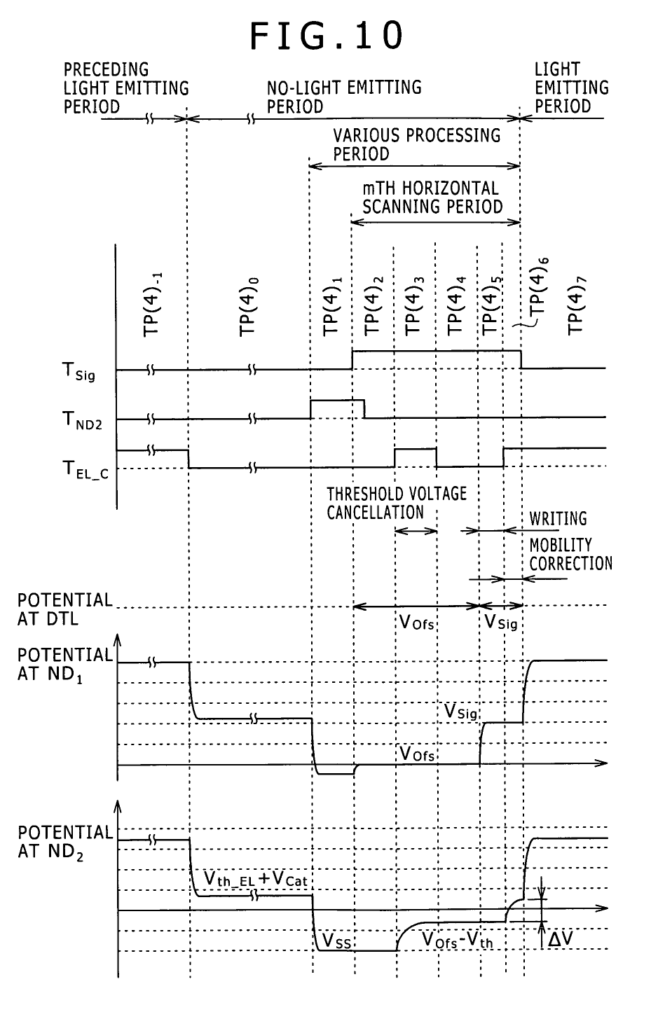

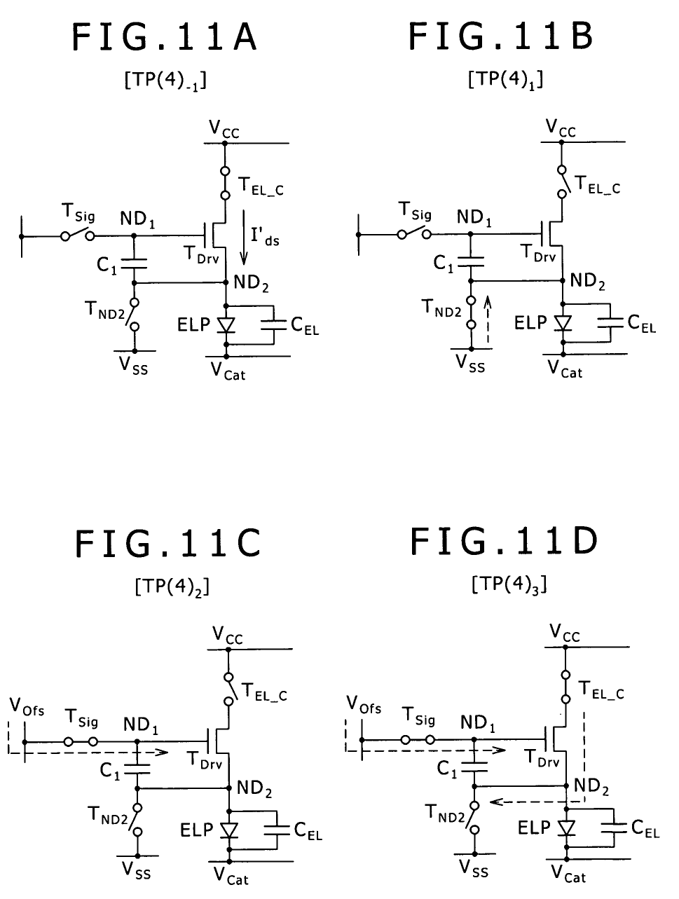

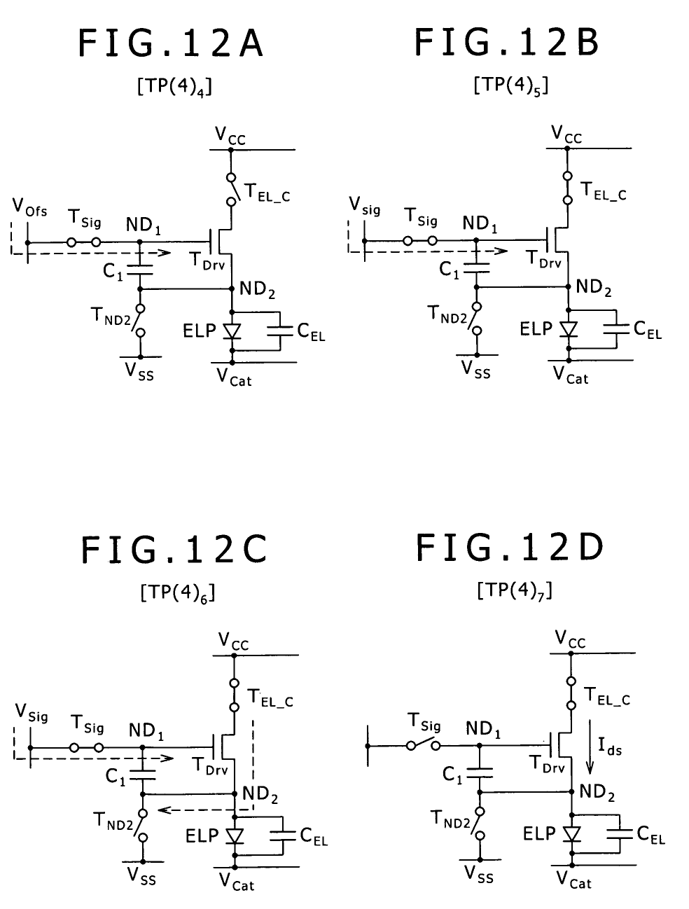

An equivalent circuit diagram of the 4Tr/1C driving circuit is shown in FIG. 8; a block diagram of the organic EL display apparatus is shown in FIG. 9; and a timing chart in driving of the 4Tr/1C driving circuit is shown in FIG. 10. Further, on/off states and so forth of transistors of the 4Tr/1C driving circuit are schematically illustrated in FIGS. 11A to 11D and 12A to 12D.

In the 4Tr/1C driving circuit, the first node initialization transistor T_{ND1} is omitted from the 5Tr/1C driving circuit described hereinabove. In particular, the 4Tr/1C driving circuit includes four transistors including an image signal writing transistor T_{Sig}, a driving transistor T_{Drv}, a light emission control transistor T_{EL}_{_{—}}_{C} and a second node initialization transistor T_{ND2} and further includes one capacitor section C₁.

### [Light Emission Control Transistor T_{EL}_{_{—}}_{C}]

The light emission control transistor T_{EL}_{_{—}}_{C} has a configuration that is the same as that of the light emission control transistor T_{EL}_{_{—}}_{C} described hereinabove in the description of the 5Tr/1C driving circuit. Therefore, overlapping description of the light emission control transistor T_{EL}_{_{—}}_{C} is omitted herein to avoid redundancy.

### [Driving Transistor T_{Drv}]

The driving transistor T_{Drv} has a configuration that is the same as that of the driving transistor T_{Drv} described hereinabove in the description of the 5Tr/1C driving circuit. Therefore, overlapping description of the driving transistor T_{Drv} is omitted herein to avoid redundancy.

### [Second Node Initialization Transistor T_{ND2}]

The second node initialization transistor T_{ND2} has a configuration that is the same as that of the second node initialization transistor T_{ND2} described hereinabove in the description of the 5Tr/1C driving circuit. Therefore, overlapping description of the second node initialization transistor T_{ND2} is omitted herein to avoid redundancy.

### [Image Signal Writing Transistor T_{Sig}]

The image signal writing transistor T_{Sig} has a configuration that is the same as that of the image signal writing transistor T_{Sig} described hereinabove in the description of the 5Tr/1C driving circuit. Therefore, overlapping description of the image signal writing transistor T_{Sig} is omitted herein to avoid redundancy. It is to be noted, however, that, although one of the source/drain regions of the image signal writing transistor T_{Sig} is connected to the data line DTL, not only the image signal V_{Sig} for controlling the luminance of the light emitting section ELP but also the voltage V_{Ofs} for initializing the gate electrode of the driving transistor T_{Drv} are supplied from the image signal outputting circuit 102 to the source/drain region. In this regard, the operation of the image signal writing transistor T_{Sig} is different from that of the image signal writing transistor T_{Sig} described hereinabove in the description of the 5Tr/1C driving circuit. It is to be noted that a signal or voltage different from the image signal V_{Sig} or the voltage V_{Ofs} such as, for example, a signal for precharge driving, may be supplied from the image signal outputting circuit 102 through the data line DTL to one of the source/drain regions.

### [Light Emitting Section ELP]

The light emitting section ELP has a configuration the is the same as that of the light emitting section ELP described hereinabove in the description of the 5Tr/1C driving circuit. Therefore, overlapping description of the light emitting section ELP is omitted herein to avoid redundancy.

In the following, operation of the 4Tr/1C driving circuit is described.

### [Period−TP(4)₋₁] (Refer to FIGS. 10 and 11A)

Within this [period−TP(4)₋₁], for example, operation for a preceding display frame is carried out. The operation in this instance is same as that within the [period−TP(5)₋₁] described hereinabove in the description of the 5Tr/1C driving circuit.

The periods of [period−TP(4)₀] to [period−TP(4)₄] illustrated in FIG. 10 correspond to the periods of [period−TP(5)₀] to [period−TP(5)₄] illustrated in FIG. 4, respectively, and are operation periods to a timing immediately before a next writing process is carried out. Similarly as in the 5Tr/1C driving circuit, the (n, m)th organic EL element 10 is in a no-light emitting state within the periods of [period−TP(4)₀] to [period−TP(4)₄]. However, the operation of the 4Tr/1C driving circuit is different from that of the 5Tr/1C driving circuit in that not only the periods of [period−TP(4)₅] to [period−TP(4)₆] but also the periods of [period−TP(4)₂] to [period−TP(4)₄] are included in the mth horizontal scanning period as illustrated in FIG. 10. It is assumed that a starting timing of the [period−TP(4)₂] and an ending timing of the [period−TP(4)₆] coincide with a starting timing and an ending timing of the mth horizontal scanning period, respectively, for the convenience of description.

In the following, operation within the periods of [period−TP(4)₀] to [period−TP(4)₄] is described. It is to be noted that the starting timing of the [period−TP(4)₁] and the lengths of the periods of [period−TP(4)₁] to [period−TP(4)₄] may be set suitably in accordance with the design of the organic EL display apparatus similarly as in the foregoing description of the 5Tr/1C driving circuit.

### [Period−TP(4)₀]

Operation within this [period−TP(4)₀] is carried out upon transition from a preceding display frame to a current display frame and is substantially the same as that within the [period−TP(5)₀] described hereinabove in the description of the 5Tr/1C driving circuit. Periods [period−TP(4)₁] to [period−TP(4)₂] (refer to

FIGS. 11B and 11C)

Within the periods, the step (a), that is, the preprocess described hereinabove, is carried-out. The preprocess is described in detail below.

[Period−TP(4)₁] (Refer to FIG. 11B) This [period−TP(4)₁] corresponds to the [period−TP(5)₁] described hereinabove in the description of the 5Tr/1C driving circuit. Upon starting of the [period−TP(4)₁], the second node initialization transistor control circuit 105 operates to set the second node initialization transistor control line AZ_{ND2} to the high level to place the second node initialization transistor T_{ND2} into an on state. As a result, the potential at the second node ND₂ becomes equal to the voltage V_{SS}, which is, for example, −10 volts. Also the potential at the first node ND₁ in a floating state, that is, at the gate electrode of the driving transistor T_{Drv}, drops so as to follow up the drop of the potential at the second node ND₂. It is to be noted that, since the potential at the first node ND₁ within the [period−TP(4)₁] depends upon the potential at the first node ND₁ within the [period−TP(4)₋₁] which in turn depends upon the value of the image signal V_{Sig} in the preceding frame, it does not assume a fixed value.

### [Period−TP(4)₂] (Refer to FIG. 11C)

Thereafter, the image signal outputting circuit 102 operates to set the potential at the data line DTL to the voltage V_{Ofs} and the scanning circuit 101 operates to set the scanning line SCL to the high level to place the image signal writing transistor T_{Sig} into an on state. As a result, the potential at the first node ND₁ becomes equal to the voltage V_{Ofs} which may be, for example, 0 volt. The potential at the second node ND₂ is maintained at the voltage V_{SS} which may be, for example, −10 volts. Thereafter, the second node initialization transistor control circuit 105 operates to set the second node initialization transistor control line AZ_{ND2} to the low level to place the second node initialization transistor T_{ND2} into an off state.

It is to be noted that the image signal writing transistor T_{Sig} may be placed into an on state simultaneously with starting of the [period−TP(4)₁] or during the [period−TP(4)₁].

By the processes described above, the potential difference between the gate electrode and the source region of the driving transistor T_{Drv} becomes greater than the threshold voltage Vₜₕ, and the driving transistor T_{Drv} is placed into an on state.

Periods [period−TP(4)₃] to [period−TP(4)₄] (Refer to FIGS. 11D and 12A)

Within the periods, the threshold voltage cancellation process provided by the step (b) described hereinabove, more particularly, by the steps (b-1) and (b-2), is carried out. In the following, the threshold voltage cancellation process is described in detail. [Period−TP(4)₃] (refer to FIG. 11D)

First, the step (b-1) described hereinabove is carried out. In particular, while the on state of the image signal writing transistor T_{Sig} is maintained, the light emission control transistor control circuit 103 operates at an initial timing of the [period−TP(4)₃] to apply the first voltage V₁_{_{—}}_{ON} for placing the light emission control circuit T_{EL}_{_{—}}_{C} into an on state to the gate electrode of the light emission control circuit T_{EL}_{_{—}}_{C} through the light emission control transistor control line CL_{EL}_{_{—}}_{C} to place the light emission control transistor T_{EL}_{_{—}}_{C} into an on state. As a result, although the potential at the first node ND₁ does not vary but maintains the voltage V_{Ofs}=0, the potential at the second node ND₂ varies toward the difference of the threshold voltage Vₜₕ of the driving transistor T_{Drv} from the potential at the first node ND₁. In other words, the potential at the second node ND₂ in a floating state rises. Then, when the potential difference between the gate electrode and the source region of the driving transistor T_{Drv} reaches the threshold voltage Vₜₕ, the driving transistor T_{Drv} enters an off state. More particularly, the potential at the second node ND₂ in a floating state approaches V_{Ofs}−Vₜₕ=−3 volts and finally becomes equal to V_{Ofs}−Vₜₕ. Here, if the expression (2) given hereinabove is assured, or in other words, if the potentials are selected and determined so as to satisfy the expression (2), then the light emitting section ELP does not emit light.

### [Period−TP(4)₄] (Refer to FIG. 12A)

Then, the step (b-2) described hereinabove is carried out. In particular, while the on state of the image signal writing transistor T_{Sig} is maintained, the light emission control transistor control circuit 103 operates at an initial timing of the [period−TP(4)₄] to apply the second voltage V₂_{_{—}}_{OFF} for placing the light emission control circuit T_{EL}_{_{—}}_{C} into an off state to the gate electrode of the light emission control circuit T_{EL}_{_{—}}_{C} through the light emission control transistor control line CL_{EL}_{_{—}}_{C}. As a result, the light emission control circuit T_{EL}_{_{—}}_{C} is placed into an off state. The potential at the first node ND₁ does not vary but maintains the voltage V_{Ofs}=0 volt, and also the potential at the second node ND₂ in a floating state maintains substantially V_{Ofs}=Vₜₕ=−3 volts.

As described above, the potential at the second node ND₂ finally becomes V_{Ofs}−Vₜₕ through the processes (b-1) and (b-2). In particular, the potential at the second node ND₂ relies only upon the threshold voltage Vₜₕ of the driving transistor T_{Drv} and the gate electrode of the driving transistor T_{Drv}. Therefore, the potential at the second node ND₂ is independent of the threshold voltage Vₜₕ_{_{—}}_{EL} of the light emitting section ELP.

Now, operation within the periods of [period−TP(4)₅] to [period−TP(4)₇] is described. Operation within those periods is substantially same as that within the periods of [period−TP(5)₅] to [period−TP(5)₇] described hereinabove in the description of the 5Tr/1C driving circuit.

### [Period−TP(4)₅] (Refer to FIG. 12B)

Within this period, the step (c), that is, the writing process described hereinabove, is carried out. In particular, while the on state of the image signal writing transistor T_{Sig} is maintained and the off state of the second node initialization transistor T_{ND2} and the light emission control circuit T_{EL}_{_{—}}_{C} is maintained, the image signal outputting circuit 102 operates to change over the potential at the data line DTL from the voltage V_{Ofs} to the image signal voltage V_{Sig} for controlling the luminance of the light emitting section ELP. As a result, the potential at the first node ND₁ rises to the image signal voltage V_{Sig}. It is to be noted that the image signal writing transistor T_{Sig} may be placed once into an off state such that, while the off state of the image signal writing transistor T_{Sig}, second node initialization transistor T_{ND2} and light emission control circuit T_{EL}_{_{—}}_{C} is maintained, the image signal outputting circuit 102 operates to change the potential at the data line DTL to the image signal voltage V_{Sig} for controlling the luminance of the light emitting section ELP, whereafter, while the off state of the second node initialization transistor T_{ND2} and the light emission control circuit T_{EL}_{_{—}}_{C} is maintained, the scanning line SCL is set to the high level to place the image signal writing transistor T_{Sig} into an on state.

With the process, the potential difference between the first node ND₁ and the second node ND₂, that is, the potential difference V_{gs} between the gate electrode and the source region of the driving transistor T_{Drv}, becomes equal to the value obtained from the expression (3) given hereinabove similarly as in the case of the 5Tr/1C driving circuit described hereinabove.

In other words, also in the 4Tr/1C driving circuit, the potential difference V_{gs} obtained in the writing process for the driving transistor T_{Drv} relies only upon the image signal V_{Sig} for controlling the luminance of the light emitting section ELP, the threshold voltage Vₜₕ of the driving transistor T_{Drv} and the voltage V_{Ofs} for initializing the gate electrode of the driving transistor T_{Drv}. In other words, the potential difference V_{gs} is independent of the threshold voltage V_{th-EL} of the light emitting section ELP.

### [Period−TP(4)₆] (Refer to FIG. 12C)

Thereafter, correction of the potential at the node region of the driving transistor T_{Drv}, that is, at the second node ND₂, based on the magnitude of the mobility μ of the driving transistor T_{Drv}, that is, a mobility correction process, is executed. In particular, operation same as that within the [period−TP(5)₆] described hereinabove in connection with the 5Tr/1C driving circuit may be carried out. It is to be noted that the total time period t₀ of the predetermined time of [period−TP(4)₆] for executing the mobility correction process may be determined in advance as a design value upon designing of the organic EL display apparatus.

### [Period−TP(4)₇] (Refer to FIG. 12D)

The threshold voltage cancellation process, writing process and mobility correction/writing process are completed by the operations described above. Thereafter, the step (d) described hereinabove is carried out within the [Period−TP(4)₇]. Thereafter, a process that is the same as that within the [period−TP(5)₇] described above in the description of the 5Tr/1C driving circuit is carried out. Consequently, since the potential at the second node ND₂ rises and soon exceeds V_{th-EL}+V_{Cat}, the light emitting section ELP starts emission of light. At this time, since the current flowing through the light emitting section ELP can be obtained from the expression (5) given hereinabove, the drain current I_{ds} flowing through the light emitting section ELP does not rely upon any of the threshold voltage V_{th-EL} of the light emitting section ELP and the threshold voltage Vₜₕ of the driving transistor T_{Drv}. In other words, the emitted light amount or luminance of the light emitting section ELP is not influenced by any of the threshold voltage V_{th-EL} of the light emitting section ELP and the threshold voltage Vₜₕ of the driving transistor T_{Drv}. In addition, appearance of a dispersion of the drain current I_{ds} arising from the dispersion of the mobility μ of the driving transistor T_{Drv} can be suppressed.

Then, the light emitting state of the light emitting section ELP is continued until the (m+m′−1)th horizontal scanning period. This point of time corresponds to the end of the [period−TP(4)₋₁].

The light emitting operation of the organic EL element 10, that is, the (n, m)th sub pixel or organic EL element 10, is completed therewith.

Now, the 3Tr/1C driving circuit is described.

### [3TR/1C Driving Circuit]

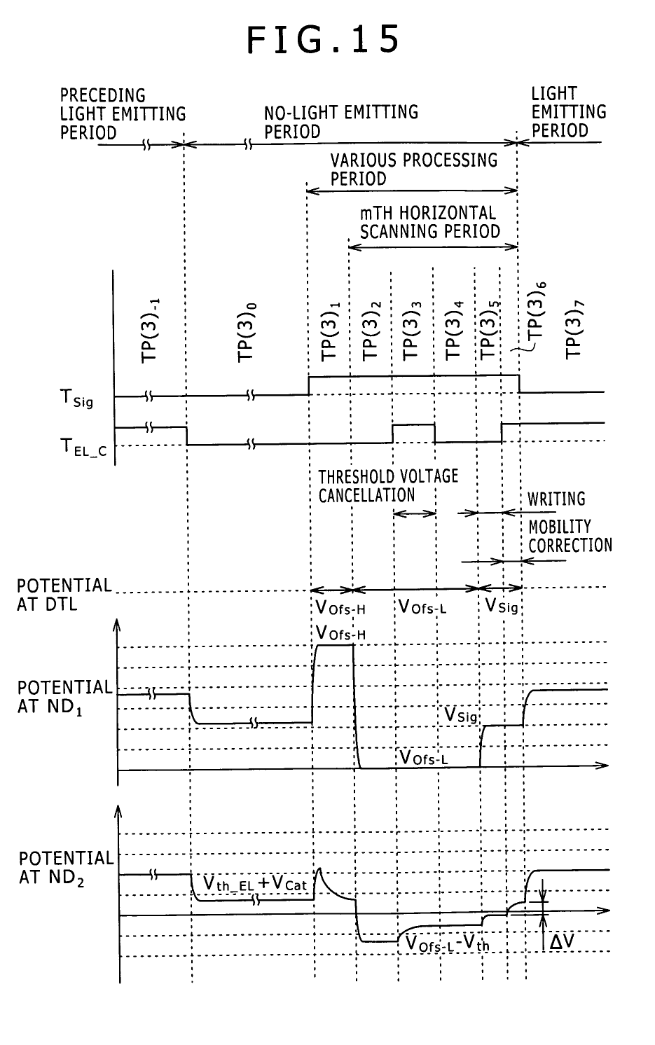

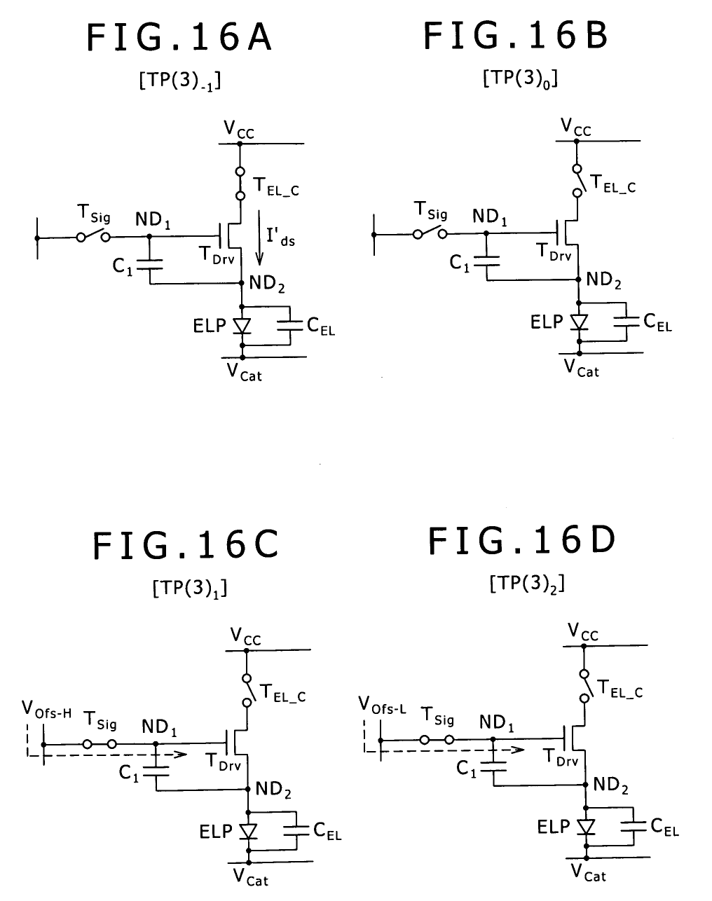

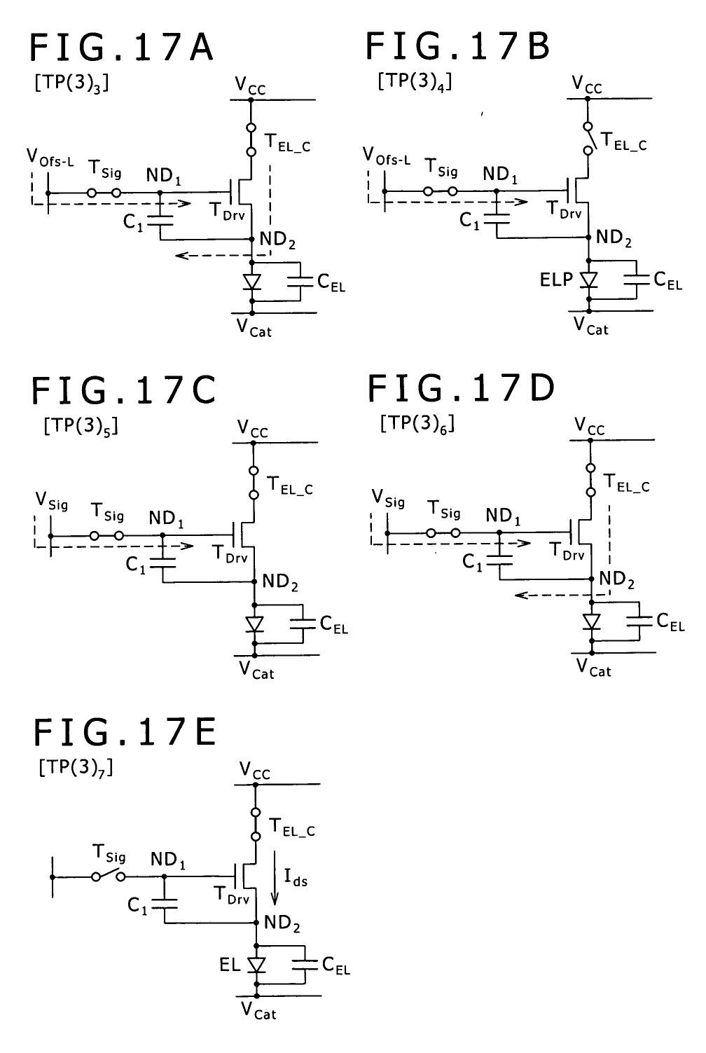

An equivalent circuit diagram of the 3Tr/1C driving circuit is shown in FIG. 13; a block diagram of the organic EL display apparatus is shown in FIG. 14; a timing chart in driving of the 3Tr/1C driving circuit is shown in FIG. 15; and on/off states of transistors and so forth of the 3Tr/1C driving circuit are schematically illustrated in FIGS. 16A to 16D and 17A to 17E.

In the 3Tr/1C driving circuit, two transistors including the first node initialization transistor T_{ND1} and the second node initialization transistor T_{ND2} are omitted from the 5Tr/1C driving circuit described hereinabove. In particular, the 3Tr/1C driving circuit includes three transistors including an image signal writing transistor T_{Sig}, a light emission control transistor T_{EL}_{_{C}} and a driving transistor T_{Drv} and further includes one capacitor section C₁.

### [Light Emission Control Transistor T_{EL}_{_{—}}_{C}]

The light emission control transistor T_{EL}_{_{—}}_{C} has a configuration that is the same as that of the light emission control transistor T_{EL}_{_{—}}_{C} described hereinabove in the description of the 5Tr/1C driving circuit. Therefore, overlapping description of the light emission control transistor T_{EL}_{_{—}}_{C} is omitted herein to avoid redundancy. [Driving Transistor T_{Drv}]

The driving transistor T_{Drv} has a configuration that is the same as that of the driving transistor T_{Drv} described hereinabove in the description of the 5Tr/1C driving circuit. Therefore, overlapping description of the driving transistor T_{Drv} is omitted herein to avoid redundancy.

### [Image Signal Writing Transistor T_{Sig}]

The image signal writing transistor T_{Sig} has a configuration that is the same as that of the image signal writing transistor T_{Sig} described hereinabove in the description of the 5Tr/1C driving circuit. Therefore, overlapping description of the image signal writing transistor T_{Sig} is omitted herein to avoid redundancy. It is to be noted, however, that, although one of the source/drain regions of the image signal writing transistor T_{Sig} is connected to the data line DTL, not only the image signal V_{Sig} for controlling the luminance of the light emitting section ELP but also a voltage V_{Ofs-H} for initializing the gate electrode of the driving transistor T_{Drv} are supplied from the image signal outputting circuit 102 to the source/drain region. In this regard, the operation of the image signal writing transistor T_{Sig} is different from that of the image signal writing transistor T_{Sig} described hereinabove in the description of the 5Tr/1C driving circuit. It is to be noted that a signal or voltage different from the image signal V_{Sig} or voltages V_{Ofs-H}/V_{Ofs-L} such as, for example, a signal for precharge driving, may be supplied from the image signal outputting circuit 102 through the data line DTL to one of the source/drain regions. Although the values of the voltage V_{Ofs-H} and the voltage V_{Ofs-L} are not limited particularly, they may be, for example,

V_{Ofs-H}=approximately 30 volts

V_{Ofs}−L=approximately 0 volt

### [Relationships of the Values of the Parasitic Capacitance C_{EL} and the Capacitance C₁]

As hereinafter described, in the 3Tr/1C driving circuit, it is necessary to utilize the data line DTL to vary the potential at the second node ND₂. It is described in the description of the 5Tr/1C driving circuit and the 4Tr/1C driving circuit that the parasitic capacitance C_{EL} has a sufficiently high value when compared with a value c₁ and a value c_{gs} and the variation of the potential in the source region of the driving transistor T_{Drv}, that is, at the second node ND₂, based on the variation V_{Sig}−V_{Ofs} of the potential at the gate electrode of the driving transistor T_{Drv} is not taken into consideration. On the other hand, in the 3Tr/1C driving circuit, the value cl is set to a value higher than those of the other driving circuits, for example, to approximately ¼ to ⅓ of the parasitic capacitance C_{EL}, depending upon the design. Accordingly, the degree of the potential variation at the second node ND₂ which arises from the potential variation at the first node ND₁ is higher than those of the other driving circuits. Therefore, in the following description of the 3Tr/1C driving circuit, the potential variation at the second node ND₂ arising from the potential variation of the first node ND₁ is taken into consideration. It is to be noted that also the driving timing chart of driving illustrated in FIG. 15 is given taking the potential variation at the second node ND₂ caused by the potential variation at the first node ND₁ into consideration.

### [Light Emitting Section ELP]

The light emitting section ELP has a configuration same as that of the light emitting section ELP described hereinabove in the description of the 5Tr/1C driving circuit. Therefore, overlapping description of the light emitting section ELP is omitted herein to avoid redundancy.

In the following, operation of the 3Tr/1C driving circuit is described.

### [Period−TP(3)₋₁] (Refer to FIG. 16A)

Within this [period−TP(3)₋₁], for example, operation for a preceding display frame is carried out. The operation within the period is same as that within the [period−TP(5)₋₁] described hereinabove in the description of the 5Tr/1C driving circuit.

The periods of [period−TP(3)₀] to [period−TP(3)₄] illustrated in FIG. 15 correspond to the periods of [period−TP(5)₀] to [period−TP(5)₄] illustrated in FIG. 4, respectively, and are operation periods to a timing immediately before a succeeding writing process is carried out. Similarly as in the 5Tr/1C driving circuit, the (n, m)th organic EL element 10 is in a no-light emitting state within the periods of [period−TP(3)₀] to [period−TP(3)₄] . However, the operation of the 3Tr/1C driving circuit is different from that of the 5Tr/1C driving circuit in that not only the periods of [period−TP(3)₅] to [period−TP(3)₆] but also the periods of [period−TP(3)₁] to [period−TP(3)₄] are included in the mth horizontal scanning period as seen in FIG. 15. It is assumed that a starting timing of the [period−TP(3)₁] and an ending timing of the [period−TP(3)₆] coincide with a starting timing and an ending timing of the mth horizontal scanning period, respectively, for the convenience of description.

In the following, operation within the periods of [period−TP(3)₀] to [period−TP(3)₄] is described. It is to be noted that the lengths of the periods of [period−TP(3)₁] to [period−TP(3)₄] may be set suitably in accordance with the design of the organic EL display apparatus similarly as in the foregoing description of the 5Tr/1C driving circuit.

### [Period−TP(3)₀] (Refer to FIG. 16B)

Operation within this [period−TP(3)₀] is carried out upon transition from a preceding display frame to a current display frame and is substantially same as that within the [period−TP(5)₀] described hereinabove in the description of the 5Tr/1C driving circuit.

Periods [period−TP(3)₁] to [period−TP(3)₂] (refer to FIGS. 16C and 16D)

Within the periods, the process (a), that is, the preprocess described hereinabove, is executed. In the following, the preprocess is described in detail.

### [Period−TP(3)₁] (Refer to FIG. 16C)

Then, the mth horizontal scanning period in the current display frame starts. Upon starting of the [period−TP(3)₁], the image signal outputting circuit 102 operates to set the potential at the data line DTL to the voltage V_{Ofs-H} for initializing the gate electrode of the driving transistor T_{Drv}, and then the scanning circuit 101 operates to set the scanning line SCL to the high level to place the image signal writing transistor T_{Sig} into an on state. As a result, the potential at the first node ND₁ becomes equal to the voltage V_{Ofs-H}. Since the value c1 of the capacitor section C₁ is set higher than those of the other driving circuits depending upon the design as described above, the potential in the source region of the driving transistor T_{Drv}, that is, the potential at the second node ND₂, rises. Then, since the potential difference across the light emitting section ELP finally exceeds the threshold voltage V_{th-EL}, the light emitting section ELP is placed into a conducting state. However, the potential in the source region of the driving transistor T_{Drv} immediately drops to V_{th-EL+V}_{Cat} again. It is to be noted that, within this process, although the light emitting section ELP can emit light, such light emission occurs at a moment and does not matter in practical use. On the other hand, the gate electrode of the driving transistor T_{Drv} maintains the voltage V_{Ofs-H}. [Period−TP(3)₂] (refer to FIG. 16D)

Thereafter, the image signal outputting circuit 102 operates to set the potential at the data line DTL from the voltage V_{Ofs-H} for initializing the gate electrode of the driving transistor T_{Drv} to the voltage V_{Ofs-L}, and consequently, the potential at the first node ND₁ becomes equal to the voltage V_{Ofs-L}. Then, together with the drop of the potential at the first node ND₁, also the potential at the second node ND₂ drops. In particular, charge based on the variation V_{Ofs-L}−V_{Ofs}-H of the potential at the gate electrode of the driving transistor T_{Drv} is distributed to the capacitor section C₁, the parasitic capacitance C_{EL} of the light emitting section ELP and the parasitic capacitance between the gate electrode and the source region of the driving transistor T_{Drv}. It is to be noted that, as a prerequisite for operation within the [period−TP(3)₃] hereinafter described, it is necessary for the potential at the second node ND₂ to be lower than V_{Ofs-L}−Vₜₕ at an ending timing of the [period−TP(3) ₂] The values of the voltage V_{Ofs-H} and so forth are set so as to satisfy this requirement. Thus, by the process described above, the potential difference between the gate electrode and the source region of the driving transistor T_{Drv} becomes greater than the threshold voltage Vₜₕ, and consequently, the driving transistor T_{Drv} is placed into an on state.

Periods [period−TP(3)₃] to [period−TP(3)₄] (Refer to FIGS. 17A and 17B)

Within the periods, the step (b) described hereinabove, that is, the threshold voltage cancellation process including the steps (b-1) and (b-2) described hereinabove, is carried out. In the following, the threshold voltage cancellation process is described in detail.

### [Period−TP(3)₃] (Refer to FIG. 17A)

First, the step (b-1) described hereinabove is carried out. In particular, while the on state of the image signal writing transistor T_{Sig} is maintained, the light emission control transistor control circuit 103 operates at an initial timing of the [period−TP(3)₃] to apply the first voltage V₁_{_{—}}_{ON} for placing the light emission control circuit T_{EL}_{_{—}}_{C} into an on state to the gate electrode of the light emission control circuit T_{EL}_{_{—}}_{C} through the light emission control transistor control line CL_{EL}_{_{—}}_{C}. Then, the light emission control circuit T_{EL}_{_{—}}_{C} is placed into an on state. As a result, although the potential at the first node ND₁ does not vary but maintains the voltage V_{Ofs-L}=0, the potential at the second node ND₂ varies from the potential at the first node ND₁ toward the difference of the threshold voltage Vₜₕ of the driving transistor T_{Drv}. In other words, the potential at the second node ND₂ in a floating state rises. Then, when the potential difference between the gate electrode and the source region of the driving transistor T_{Drv} reaches the threshold voltage Vₜₕ, the driving transistor T_{Drv} enters an off state. More particularly, the potential at the second node ND₂ in a floating state approaches V_{Ofs}−Vₜₕ=−3 volts and finally becomes equal to V_{Ofs}−Vₜₕ. Here, if the expression (2) given hereinabove is assured, or in other words, if the potentials are selected and determined so as to satisfy the expression (2), then the light emitting section ELP does not emit light.

### [Period−TP(3)₄] (Refer to FIG. 17B)

Then, the step (b-2) described hereinabove is carried out. In particular, while the on state of the image signal writing transistor T_{Sig} is maintained, the light emission control transistor control circuit 103 operates at an initial timing of the [period−TP(3)₄] to apply the second voltage V₂_{_{—}}_{OFF} for placing the light emission control circuit T_{EL}_{_{—}}_{C} into an off state to the gate electrode of the light emission control circuit T_{EL}_{_{—}}_{C} through the light emission control transistor control line CL_{EL}_{_{—}}_{C}. As a result, the light emission control circuit T_{EL}_{_{—}}_{C} is placed into an off state. The potential at the first node ND₁ does not vary but maintains the voltage V_{Ofs}=0 volt, and also the potential at the second node ND₂ in a floating state maintains substantially V_{Ofs}−Vₜₕ=−3 volts.

As described above, the potential at the second node ND₂ finally becomes V_{Ofs}−Vₜₕ through the processes (b-1) and (b-2). Thus, the potential at the second node ND₂ relies only upon the threshold voltage Vₜₕ of the driving transistor T_{Drv} and the gate electrode of the driving transistor T_{Drv}. Therefore, the potential at the second node ND₂ is independent of the threshold voltage Vₜₕ_{_{—}}_{EL} of the light emitting section ELP.

Now, operation within the periods of [period−TP(3)₅] to [period−TP(3)₇] is described. Operation within those periods is substantially same as that within the [period−TP(5)₅] to [period−TP(5)₇] described hereinabove in the description of the 5Tr/1C driving circuit.

### [Period−TP(3)₅] (Refer to FIG. 17C)

Within this period, the step (c), that is, the writing process described hereinabove, is carried out. In particular, while the on state of the image signal writing transistor T_{Sig} is maintained and the off state of the light emission control circuit T_{EL}_{_{—}}_{C} is maintained, the image signal outputting circuit 102 operates to set the potential at the data line DTL from the voltage V_{Ofs} to the image signal voltage V_{Sig} for controlling the luminance of the light emitting section ELP. As a result, the potential at the first node ND₁ rises to the image signal voltage V_{Sig}. It is to be noted that the image signal writing transistor T_{Sig} may be placed once into an off state such that, while the off state of the image signal writing transistor T_{Sig} and light emission control circuit T_{EL}_{_{—}}_{C} is maintained, the potential at the data line DTL is changed to the image signal V_{Sig} for controlling the luminance of the light emitting section ELP, whereafter, while the off state of the light emission control circuit T_{EL}_{_{—}}_{C} is maintained, the scanning line SCL is set to the high level to place the image signal writing transistor T_{Sig} into an on state.

Within the [period−TP(3)₅], the potential at the first node ND₁ rises to the image signal V_{Sig}. Therefore, where the potential variation at the second node ND₂ which is caused by the potential variation at the first node ND₁ is taken into consideration, also the potential at the second node ND₂ rises a little. Therefore, the potential at the second node ND₂ can be represented as V_{Ofs-L}−Vₜₕ+α·(V_{Sig}−V_{Ofs-L}). Here, the value of α satisfies 0<α<1 and depends upon the capacitor section C₁ and the parasitic capacitance C_{EL} of the light emitting section ELP.

Consequently, similarly as in the foregoing description of the 5Tr/1C driving circuit, the potential difference between the first node ND₁ and the second node ND₂, that is, the potential difference V_{gs} between the gate electrode and the source region of the driving transistor T_{Drv}, can have a value given by the following expression (3′):

V_{gs}≈V_{Sig}−(V_{Ofs-L}−Vₜₕ)−α·(V_{Sig}−V_{Ofs-L}) (3′)

Thus, also in the 3Tr/1C driving circuit, the potential difference V_{gs} obtained by the writing process for the driving transistor T_{Drv} relies only upon the image signal voltage V_{Sig} for controlling the luminance of the light emitting section ELP, the threshold voltage Vₜₕ of the driving transistor T_{Drv} and the voltage V_{Ofs-L} for initializing the gate electrode of the driving transistor T_{Drv}. Therefore, the potential difference V_{gs} is independent of the threshold voltage Vₜₕ_{_{—EL of the light emitting section ELP.}}

### [Period−TP(3)₆] (Refer to FIG. 17D)

Then, correction, that is, a mobility correction process, of the potential at the source region of the driving transistor T_{Drv}, that is, at the second node ND₂, based on the magnitude of the mobility μ of the driving transistor T_{Drv} is carried out. In other words, a mobility correction/writing process is executed. In particular, operation same as that within the [period−TP(5)₆] described hereinabove in the description of the 5Tr/1C driving circuit may be executed. It is to be noted that the predetermined time for executing the mobility correction process, that is, the total time t₀ of the [period−TP(3)₆] may be determined in advance as a design value upon designing of the organic EL display apparatus. [Period−TP(3)₇] (refer to FIG. 17E)

The threshold voltage cancellation process, writing process and mobility correction/writing process are completed by the operations described above. Thereafter, the process (d) described hereinabove is carried out in the following manner within the period. In particular, a process same as that within the [period−TP(5)₇] described above in the description of the 5Tr/1C driving circuit is carried out. Consequently, since the potential at the second node ND₂ rises and exceeds V_{th-EL}+V_{Cat}, the light emitting section ELP starts emission of light. At this time, since the current flowing through the light emitting section ELP can be obtained from the expression (5) given hereinabove, the drain current I_{ds} flowing through the light emitting section ELP does not rely upon any of the threshold voltage V_{th-EL} and the threshold voltage Vₜₕ of the driving transistor T_{Drv}. In other words, the emitted light amount or luminance of the light emitting section ELP is not influenced by any of the threshold voltage V_{th-EL} of the light emitting section ELP and the threshold voltage Vₜₕ of the driving transistor T_{Drv}. In addition, appearance of a dispersion of the drain current I_{ds} arising from the dispersion of the mobility μ of the driving transistor T_{Drv} can be suppressed.

Then, the light emitting state of the light emitting section ELP is continued till the (m+m′−1)th horizontal scanning period. This point of time corresponds to the end of the [period−TP(3)₋₁].

The light emitting operation of the organic EL element 10, that is, the (n, m)th sub pixel or organic EL element 10, is completed therewith.

While a preferred embodiment of the present invention has been described using specific terms, such description is for illustrative purpose only, and it is to be understood that changes and variations may be made without departing from the spirit or scope of the following claims. In particular, the configuration and the structure of various components of the organic EL display apparatus, organic EL elements and driving circuit described hereinabove in connection with the embodiment of the present invention and the steps of the driving method for the light emitting section are illustrative but can be modified suitably.

What is claimed is:

1. A driving method for an organic electroluminescence light emitting section of an organic EL display apparatus which includes
(1) a scanning circuit,
(2) an image signal outputting circuit,
(3) totaling N×M organic electroluminescence elements disposed in a two-dimensional matrix wherein N organic electroluminescence elements are arrayed in a first direction and M organic electroluminescence elements are arrayed in a second direction different from the first direction and each including an organic electroluminescence light emitting section and a driving circuit for driving the organic electroluminescence light emitting section,
(4) M scanning lines connected to the scanning circuit and extending in the first direction,
(5) N data lines connected to the image signal outputting circuit and extending in the second direction, and
(6) a current supplying section,
the driving circuit including
(A) a driving transistor including source/drain regions, a channel formation region, and a gate electrode,
(B) an image signal writing transistor including source/drain regions, a channel formation region, and a gate electrode,
(C) a light emission control transistor including source/drain regions, a channel formation region, and a gate electrode, and
(D) a capacitor section having a pair of electrodes,
the driving transistor being configured such that
(A-1) a first one of the source/drain regions is connected to a second one of the source/drain regions of the light emission control transistor, that
(A-2) a second one of the source/drain regions is connected to an anode electrode provided in the organic electroluminescence light emitting section and is connected to a first one of the electrodes of the capacitor section to form a second node, and that
(A-3) the gate electrode is connected to a second one of the source/drain regions of the image signal writing transistor and is connected to a second one of the electrodes of the capacitor section to form a first node,
the image signal writing transistor being configured such that
(B-1) a first one of the source/drain regions is connected to a data line, and that
(B-2) the gate electrode is connected to a scanning line,
the light emission control transistor being configured such that
(C-1) a first one of the source/drain regions is connected to a current supplying section, and that
(C-2) the gate electrode is connected to a light emission control transistor control line,
the driving method for the organic electroluminescence light emitting section of the organic EL display apparatus, comprising the steps of:
(a) carrying out a preprocess of applying a first node initialization voltage to the first node and applying a second node initialization voltage to the second node so that a potential difference between the first and second nodes exceeds a threshold voltage of the driving transistor and a potential difference between the second node and a cathode electrode of the organic electroluminescence light emitting section does not exceed a threshold voltage of the organic electroluminescence light emitting section;
(b) carrying out a threshold voltage cancellation process for varying the potential at the second node toward a potential of the difference of the threshold voltage of the driving transistor from the potential at the first node while the potential at the first node is maintained;
(c) carrying out a wiring process of applying an image signal from the data line to the first node through the image signal writing transistor which is placed into an on state with a signal from the scanning line; and
(d) placing the image signal writing transistor into an off state with a signal from the scanning line to place the first node into a floating state and supplying current corresponding to the value of the potential difference between the first node and the second node from the current supplying section to the organic electroluminescence light emitting section through the light emission control transistor and the driving transistor to drive the organic electroluminescence light emitting section;
the step (b) including the steps of
(b-1) applying a first voltage for placing the light emission control transistor into an on state to the gate electrode of the light emission control transistor through the light emission controlling transistor control section to connect one of the source/drain regions of the driving transistor to the current supplying section through the light emission controlling transistor in the on state to set the potential at the one of the source/drain region of the driving transistor to a potential higher than the potential at the second node at the step (a), and
(b-2) applying a second voltage for placing the light emission controlling transistor to the gate electrode of the light emission controlling transistor through the light emission controlling transistor control line,
the step (d) further including applying a third voltage for placing the light emission controlling transistor into an on state to the gate electrode of the light emission controlling transistor through the light emission controlling transistor control line and connecting the one of the source/drain regions of the driving transistor to the current supplying section through the light emission controlling transistor in an on state to supply current corresponding to the value of the potential difference between the first node and the second node to the organic electroluminescence light emitting section,
the first, second and third voltages satisfying |V₁_{_{—}}_{ON}−V₂_{_{—}}_{OFF}|<|V₃_{_{—}}_{ON}−V₂_{_{—}}_{OFF}| where V₁_{_{—}}_{ON} is the first voltage, V₂_{_{—}}_{OFF} is the second voltage and V₃_{_{—}}_{ON} is the third voltage.

2. The driving method according to claim 1, wherein the driving circuit further includes
(E) a second node initialization transistor including source/drain regions, a channel formation region, and a gate electrode,
in the second node initialization transistor:
(E-1) a first one of the source/drain regions is connected to a second node initialization voltage supply line;
(E-2) a second one of the source/drain regions is connected to the second node; and
(E-3) the gate electrode is connected to a second node initialization transistor control line;
at the step (a), a second node initialization voltage is applied from the second node initialization voltage supply line to the second node through the second node initialization transistor which is placed in an on state with a signal from the second node initialization transistor control line, and then the second node initialization transistor is placed into an off state with a signal from the second node initialization transistor control line.

3. The driving method according to claim 2, wherein the driving circuit further includes
(F) a first node initialization transistor including source/drain regions, a channel formation region, and a gate electrode,
in the first node initialization transistor:
(F-1) a first one of the source/drain regions is connected to a first node initialization voltage supply line;
(F-2) a second one of the source/drain regions is connected to the first node; and
(F-3) the gate electrode is connected to the first node initialization control line;
at the step (a), a first node initialization voltage is applied from the first node initialization voltage supply line to the first node through the first node initialization transistor which is placed in an on state with a signal from the first node initialization transistor control line.
